(19) United States
(12) Patent Application Publication
(10) Pub. No.: US 2016/0198453 A1
(43) Pub. Date: Jul. 7, 2016

(54) Method, Device, and System for Sending Feedback Information

(71) Applicant: Huawei Technologies Co., Ltd., Shenzhen (CN)

(72) Inventors: Zhenxing Hu, Shenzhen (CN); Wei Quan, Beijing (CN); Xiaodong Yang, Beijing (CN); Jian Zhang, Beijing (CN)

(21) Appl. No.: 15/068,235

(22) Filed: Mar. 11, 2016

Related U.S. Application Data
(63) Continuation of application No. PCT/CN2013/083479, filed on Sep. 13, 2013.

(51) Int. Cl. H04W 72/04; H04L 1/18; H04L 29/06; H04W 24/02

(52) U.S. Cl. CPC H04W 72/048; H04W 24/02; H04L 1/1812; H04L 69/22; H04W 72/042; H04L 1/1864; H04W 88/02

(57) ABSTRACT

Embodiments relate to the field of communications technologies, and disclose a method, device, and system for sending feedback information, to enable a receive end to transmit feedback information without using a PUCCH/PHICH feedback channel, so as to improve system efficiency. The method includes: receiving, by a receive end device, data sent by a transmit end device; generating, according to the received data, a protocol data unit PDU carrying feedback information, where the feedback information is used to indicate whether the receive end device receives the data correctly; and sending, to the transmit end device, the PDU carrying the feedback information.

This application is a continuation of International Application No. PCT/CN2013/083479, filed on Sep. 13, 2013, which is hereby incorporated by reference in its entirety.

### TECHNICAL FIELD

The present invention relates to the field of communications technologies, and in particular, to a method, device, and system for sending feedback information.

### BACKGROUND

In a current communications system, a hybrid automatic repeat request (HARQ) mechanism is used to send feedback information. A HARQ entity at a media access control (MAC) layer is responsible for implementing the HARQ mechanism. The HARQ mechanism includes: an uplink feedback for downlink data is transmitted on a physical uplink control channel (PUCCH), and a downlink feedback for uplink data is transmitted on a physical HARQ indicator channel (PHICH).

For some user equipment devices (UE) such as a power meter terminal placed in an iron box or a basement, because the user equipment may be located in an area with relatively poor coverage of a base station, an extra signal loss may occur. Therefore, to compensate for such a loss, the base station uses a manner of repeated sending. For different physical channels, different quantities of times, in a range from dozens to hundreds of times, of repetition are required. When a quantity of repeated physical channels increases, system efficiency decreases because a manner of repeated sending is required. Therefore, for such a type of user equipment, a PUCCH/PHICH feedback channel may be not used. In this case, because the UE does not feedback whether information sent by the base station is received, the base station cannot know whether data is correctly received by the UE, and has to use a manner of not performing retransmission or a blind retransmission manner, causing relatively low system efficiency.

A problem to be resolved by the present invention is how to enable a receive end to transmit feedback information without using a PUCCH/PHICH feedback channel, so as to improve system efficiency.

### SUMMARY

Embodiments provide a method, device, and system for sending feedback information, to enable a receive end to transmit feedback information without using a PUCCH/PHICH feedback channel, so as to improve system efficiency.

To achieve the foregoing objective, the following technical solutions are used in the embodiments.

According to a first aspect, embodiments provide a method for sending feedback information, including: receiving, by a receive end device, data sent by a transmit end device. The method also includes generating, according to the received data, a protocol data unit (PDU) carrying feedback information, where the feedback information is used to indicate whether the receive end device receives the data correctly. The method also includes sending, to the transmit end device, the PDU carrying the feedback information.

In a first possible implementation manner, according to the first aspect, the generating, according to the received data, a protocol data unit PDU carrying feedback information includes: generating, according to the received data, a media access control (MAC) layer PDU carrying the feedback information.

In a second possible implementation manner, according to the first possible implementation manner, the generating a MAC layer PDU carrying the feedback information includes: using a bit in any sub-header of the MAC PDU to carry the feedback information about whether the data is received correctly; or using a control information element (CE) in the MAC PDU to carry the feedback information about whether the data is received correctly, where the MAC PDU includes a logical channel identifier (LCID) used to denote that the MAC CE is used to carry the feedback information.

In a third possible implementation manner, according to the second possible implementation manner, the using a control information element CE in the MAC PDU to carry the feedback information about whether the data is received correctly includes: the MAC CE includes N information bits, and the information bits correspond to HARQ process IDs; or the MAC CE includes N information bits and one HARQ process ID, where any one of the N information bits corresponds to the HARQ process ID, and the remaining N−1 information bits correspond to other HARQ process IDs; where each of the information bits is used to denote whether the receive end device correctly receives data that is sent by the transmit end device and that corresponds to a HARQ process ID.

In a fourth possible implementation manner, according to the first aspect, the generating, according to the received data, a protocol data unit (PDU) carrying feedback information includes: generating, according to the received data, a radio link control RLC layer PDU carrying the feedback information. The RLC PDU includes: a data identifier and N information bits, and the N information bits correspond to the data received by the receive end device; or a control identifier, a control content identifier, and N information bits, and the N information bits correspond to control information received by the receive end device. Each of the information bits is used to denote whether the receive end device correctly receives data that is sent by the transmit end device and that corresponds to a process ID.

In a fifth possible implementation manner, with reference to the first aspect or any one of the foregoing four possible implementation manners, the sending, to the transmit end device, the PDU carrying the feedback information includes: determining a sending time of the PDU carrying the feedback information; and sending, to the transmit end device at the sending time, the PDU carrying the feedback information.

In a sixth possible implementation manner, according to the fifth possible implementation manner, the determining a sending time of the PDU carrying the feedback information includes: determining, according to a moment when the receive end device receives the data, a quantity of times that the receive end device receives the data, and a time during which the receive end device processes the received data, a sending moment for sending a feedback.

In a seventh possible implementation manner, according to the fifth possible implementation manner, the determining a sending time of the PDU carrying the feedback information includes: determining a sending moment of a feedback according to a first formula, where the first formula is: T=t+n−1+k, where T denotes the sending moment of the feedback, t denotes a moment when the receive end device receives the data, n denotes a quantity of times that the receive end device repeats the received data, and k denotes a time during which the receive end device processes the received data.

In an eighth possible implementation manner, according to the fifth possible implementation manner, the determining a sending time of the PDU carrying the feedback information includes: determining, according to a moment when the receive end device receives the data, a quantity of times that the receive end device receives the data, a time during which the receive end device processes the received data, and a feedback time window preconfigured by the receive end device, a sending time period for sending the feedback information.

In a ninth possible implementation manner, according to the fifth possible implementation manner, the determining a sending time of the PDU carrying the feedback information includes: determining a start moment T1 of a sending time period according to a second formula, and determining an end moment T2 of the sending time period according to a third formula, where the second formula is:

T1=t+n−1+k, and

the third formula is:

T2=t+n−1+k+w,

where t denotes a moment when the receive end device receives the data, n denotes a quantity of times that the receive end device repeats the received data, k denotes a time during which the receive end device processes the received data, and w denotes a feedback time window preconfigured by the receive end device.

In a tenth possible implementation manner, with reference to the eighth or ninth possible implementation manner, the feedback time window preconfigured by the receive end device is a fixed value configured initially.

In an eleventh possible implementation manner, with reference to any one of the eighth to tenth possible implementation manners, if the receive end device is user equipment, and the transmit end device is a base station, the feedback time window preconfigured by the receive end device is configured for the receive end device by the transmit end device by using a radio resource control RRC message.

In a twelfth possible implementation manner, with reference to any one of the eighth to eleventh possible implementation manners, within the sending time period for sending the feedback information, the sending, to the transmit end device at the sending time, the PDU carrying the feedback information includes: sending, by the receive end device, the feedback information to the transmit end device at the first moment, within the sending time period, having a first resource, where the first resource is a resource that can be used to send the feedback information.

In a thirteenth possible implementation manner, with reference to the first aspect or the foregoing four possible implementation manners, the sending, to the transmit end device, the PDU carrying the feedback information includes: sending, to the transmit end device, the first PDU that has data to be sent and that carries the feedback information.

According to a second aspect, embodiments provide a method for sending feedback information, including: sending, by user equipment, data to a base station; and receiving, by the user equipment, feedback information that is sent by the base station and that is scheduled by using a physical downlink control channel PDCCH scrambled with a radio network temporary identifier RNTI, where the feedback information is used to indicate whether the base station receives the data correctly.

In a first possible implementation manner, according to the second aspect, before the sending, by user equipment, data to a base station, the method further includes: performing, by the user equipment, grouping according to an identifier of the user equipment, to obtain a group identifier; and acquiring, by the user equipment according to the group identifier, a feedback information receiving parameter of a group to which the user equipment belongs, where the feedback information receiving parameter is used to identify that the user equipment receives, on an allocated resource, the feedback information that is sent by the base station. The receiving, by the user equipment feedback information that is sent by the base station and that is scheduled by using a PDCCH scrambled with an RNTI includes: receiving, by the user equipment, the feedback information that is sent by the base station and that is scheduled, when the feedback information receiving parameter of the group to which the user equipment belongs is used, by using the PDCCH scrambled with one common RNTI.

In a second possible implementation manner, according to the second aspect, before the sending, by user equipment, data to a base station, the method further includes: performing, by the user equipment, grouping according to an identifier of the user equipment, to obtain a group identifier; and acquiring, according to the group identifier, a feedback information receiving parameter of the user equipment, and an RNTI of a group to which the user equipment belongs, where the feedback information receiving parameter is used to identify that the user equipment receives, on an allocated resource, the feedback information that is sent by the base station. The receiving, by the user equipment feedback information that is sent by the base station and that is scheduled by using a PDCCH scrambled with an RNTI includes: receiving, by the user equipment, the feedback information that is sent by the base station and that is scheduled, when the feedback information receiving parameter is used, by using the PDCCH scrambled with the RNTI of the group to which the user equipment belongs.

In a third possible implementation manner, according to the second aspect, before the sending, by user equipment, data to a base station, the method further includes: performing, by the user equipment, grouping according to an identifier of the user equipment, to obtain a group identifier; and acquiring, according to the group identifier, an RNTI of a group to which the user equipment belongs; and the receiving, by the user equipment feedback information that is sent by the base station and that is scheduled by using a PDCCH scrambled with an RNTI includes: receiving, by the user equipment, the feedback information that is sent by the base station and that is scheduled, within a sending time period for sending a feedback, by using the PDCCH scrambled with the RNTI of the group to which the user equipment belongs, where the sending time period is a sending time period, for sending the feedback, determined after the base station processes the data sent by the user equipment.

In a fourth possible implementation manner, according to any one of the foregoing three possible implementation manners, the performing, by the user equipment, grouping according to an identifier of the user equipment, to obtain a group identifier includes: dividing, by the user equipment, the identifier of the user equipment by a grouping quantity M, to obtain a remainder; and using the remainder as the group identifier of the user equipment.

In a fifth possible implementation manner, according to any one of the foregoing four possible implementation manners, the grouping quantity M is configured for the user equipment by the base station in a broadcast manner, or the grouping quantity M is initially configured for the user equipment.

In a sixth possible implementation manner, with reference to the second aspect or any one of the foregoing five possible implementation manners, the feedback information includes: an identifier of at least one user equipment, at least one HARQ process ID, and N information bits, where the N information bits correspond to the HARQ process ID, and each of the information bits is used to denote whether the base station correctly receives data that is sent by the user equipment and that corresponds to a HARQ process ID.

According to a third aspect, the present invention provides a method for sending feedback information, including: receiving, by a base station, data sent by user equipment, where the data includes an identifier of the user equipment; generating, by the base station, feedback information according to the received data sent by the user equipment, where the feedback information is used to identify whether the base station correctly receives the data sent by the user equipment; and sending, by the base station to the user equipment, the feedback information scheduled by using a physical downlink control channel PDCCH scrambled with a radio network temporary identifier RNTI.

In a first possible implementation manner, according to the third aspect, before the receiving, by a base station, data sent by user equipment, the base station is preconfigured with: one common RNTI, a grouping quantity M of user equipments, and a feedback information receiving parameter of a group to which the user equipment belongs. After the receiving, by a base station, data sent by user equipment, the method further includes: performing, by the base station, grouping according to the identifier, of the user equipment, in the data sent by the user equipment, to obtain a group identifier of the user equipment; and acquiring, by the base station according to the group identifier, the feedback information receiving parameter of the group to which the user equipment belongs. The sending, by the base station to the user equipment, the feedback information scheduled by using a PDCCH scrambled with an RNTI includes: sending, by the base station to the user equipment according to the feedback information receiving parameter of the group to which the user equipment belongs, the feedback information scheduled by using the PDCCH scrambled with one common RNTI.

In a second possible implementation manner, according to the third aspect, before the receiving, by a base station, data sent by user equipment, the base station is preconfigured with: a grouping quantity M of user equipments, M RNTIs, and a feedback information receiving parameter of the user equipment. After the receiving, by a base station, data sent by user equipment, the method further includes: performing, by the base station, grouping according to the identifier, of the user equipment, in the data sent by the user equipment, to obtain a group identifier of the user equipment; and acquiring, by the base station, according to the group identifier, an RNTI of a group to which the user equipment belongs and the feedback information receiving parameter. The sending, by the base station to the user equipment, the feedback information scheduled by using a PDCCH scrambled with an RNTI includes: sending, by the base station to the user equipment according to the feedback information receiving parameter of the user equipment, the feedback information scheduled by using the PDCCH scrambled with the RNTI of the group to which the user equipment belongs.

In a third possible implementation manner, according to the third aspect, before the receiving, by a base station, data sent by user equipment, the base station is preconfigured with: a grouping quantity M of user equipments, and M RNTIs, where groups of the user equipments correspond to the RNTIs one by one. After the receiving, by a base station, data sent by user equipment, the method further includes: performing, by the base station, grouping according to the identifier, of the user equipment, in the data sent by the user equipment, to obtain a group identifier of the user equipment; and acquiring, by the base station, according to the group identifier, the RNTI of the group to which the user equipment belongs. The sending, by the base station to the user equipment, the feedback information scheduled by using a PDCCH scrambled with an RNTI includes: sending, by the base station to the user equipment, the feedback information that is scheduled, within a sending time period for sending a feedback, by using the PDCCH scrambled with the RNTI of the group to which the user equipment belongs, where the sending time period is a sending time period, for sending the feedback, determined after the base station processes the data sent by the user equipment.

In a fourth possible implementation manner, according to any one of the foregoing three possible implementation manners, the performing, by the user equipment, grouping according to the identifier of the user equipment, to obtain a group identifier includes: dividing, by the user equipment, the identifier of the user equipment by the grouping quantity M, to obtain a remainder; and using the remainder as the group identifier of the user equipment.

In a fifth possible implementation manner, with reference to the third aspect or any one of the foregoing four possible implementation manners, the feedback information includes: an identifier of at least one user equipment, at least one HARQ process ID, and N information bits, where the N information bits correspond to the HARQ process ID, and each of the information bits is used to denote whether the base station correctly receives data that is sent by the user equipment and that corresponds to a HARQ process ID.

According to a fourth aspect, embodiments provide a method for sending feedback information, including: sending, by a base station, uplink-downlink time configuration information to user equipment, where the user equipment supports a change in uplink-downlink time ratio allocation; and receiving, by the base station, feedback information sent by the user equipment, where the feedback information is used to identify whether the user equipment receives the uplink-downlink time configuration information sent by the base station.

In a first possible implementation manner, according to the fourth aspect, the receiving, by the base station, feedback information sent by the user equipment includes: receiving, by the base station, a media access control MAC layer PDU that is sent by the user equipment and that carries the feedback information.

In a second possible implementation manner, according to the first possible implementation manner, the media access control MAC layer PDU carrying the feedback information includes: using a bit in any sub-header of the MAC PDU to carry the feedback information about whether the user equipment receives the uplink-downlink time configuration information sent by the base station; or using a logical channel identifier LCID of the MAC PDU to identify the feedback information about whether the user equipment receives the uplink-downlink time configuration information sent by the base station; or using a control information element CE in the MAC PDU to carry the feedback information about whether the user equipment receives the uplink-downlink time configuration information sent by the base station, where the MAC PDU includes a logical channel identifier LCID used to identify that the MAC CE is used to carry the feedback information.

In a third possible implementation manner, according to the fourth aspect, the receiving, by the base station, feedback information sent by the user equipment includes: receiving, by the base station, an enhanced scheduling request SR that is sent by the user equipment and that carries the feedback information.

In a fourth possible implementation manner, according to the fourth aspect, the receiving, by the base station, feedback information sent by the user equipment includes: receiving, by the base station, an enhanced downlink-data uplink-feedback ACK/NACK that is sent by the user equipment and that carries the feedback information.

In a fifth possible implementation manner, according to the fourth aspect, before the sending, by a base station, uplink-downlink configuration information to user equipment, the method further includes: allocating, by the base station to the user equipment, a resource used to feed back whether the uplink-downlink time configuration information is received; the receiving, by the base station, feedback information of the user equipment includes: receiving, by the base station on the resource allocated to the user equipment for the feedback, the feedback information sent by the user equipment.

In a sixth possible implementation manner, with reference to the first aspect or any one of the foregoing five possible implementation manners, the receiving, by the base station, feedback information of the user includes: if the user equipment receives the uplink-downlink time configuration information sent by the base station, receiving, by the base station, the feedback information sent by the user equipment; and/or if the user equipment does not receive the uplink-downlink time configuration information sent by the base station, receiving, by the base station, the feedback information sent by the user equipment.

According to a fifth aspect, the embodiments provide a method for sending feedback information, including: receiving, by user equipment, uplink-downlink time configuration information sent by a base station, where the user equipment supports a change in uplink-downlink time ratio allocation; generating, by the user equipment, feedback information according to whether the uplink-downlink time configuration information sent by the base station is received, where the feedback information is used to identify whether the user equipment receives the uplink-downlink time configuration information sent by the base station; and sending, by the user equipment, the feedback information to the base station.

In a first possible implementation manner, according to the fifth aspect, the sending, by the user equipment, the feedback information to the base station includes: sending, by the user equipment to the base station, a media access control MAC layer PDU carrying the feedback information.

In a second possible implementation manner, according to the first possible implementation manner, the media access control MAC layer PDU carrying the feedback information includes: using a bit in any sub-header of the MAC PDU to carry the feedback information about whether the user equipment receives the uplink-downlink time configuration information sent by the base station; or using a logical channel identifier LCID of the MAC PDU to identify the feedback information about whether the user equipment receives the uplink-downlink time configuration information sent by the base station; or using a control information element CE in the MAC PDU to carry the feedback information about whether the user equipment receives the uplink-downlink time configuration information sent by the base station, where the MAC PDU includes a logical channel identifier LCID used to identify that the MAC CE is used to carry the feedback information.

In a third possible implementation manner, according to the fifth aspect, the sending, by the user equipment, the feedback information to the base station includes: sending, by the user equipment to the base station, an enhanced scheduling request SR carrying the feedback information.

In a fourth possible implementation manner, according to the fifth aspect, the sending, by the user equipment, the feedback information to the base station includes: sending, by the user equipment to the base station, an enhanced downlink-data uplink-feedback ACK/NACK carrying the feedback information.

In a fifth possible implementation manner, according to the fifth aspect, the sending, by the user equipment, the feedback information to the base station includes: sending, by the user equipment, the feedback information to the base station on a resource that is allocated by the base station to the user equipment and that is used to feed back whether the uplink-downlink time configuration information is received.

In a sixth possible implementation manner, with reference to the fifth aspect or any one of the foregoing five possible implementation manners, the sending, by the user equipment, the feedback information to the base station includes: if the user equipment receives the uplink-downlink time configuration information, sending, by the user equipment, the feedback information to the base station; and/or if the user equipment does not receive the uplink-downlink time configuration information, sending, by the user equipment, the feedback information to the base station.

According to a sixth aspect, the embodiments provide a device for sending feedback information, including: a receiving module, configured to receive data sent by a transmit end device; and a feedback information generation module, configured to generate, according to the data received by the receiving module, a protocol data unit PDU carrying feedback information, where the feedback information is used to indicate whether the receive end device receives the data correctly. The device also includes a sending module, configured to send, to the transmit end device, the PDU carrying the feedback information.

In a first possible implementation manner, according to the sixth aspect, the feedback information generation module is specifically configured to generate, according to the data received by the receiving module, a media access control MAC layer PDU carrying the feedback information.

In a second possible implementation manner, according to the sixth aspect, the feedback information generation module is specifically configured to generate, according to the received data, a radio link control RLC layer PDU carrying the feedback information.

In a third possible implementation manner, with reference to the sixth aspect or either of the foregoing two possible implementation manners, the sending module includes: a determining unit and a sending unit, where the determining unit is configured to determine a sending time of the PDU carrying the feedback information; and the sending unit is configured to send, to the transmit end device at the sending time determined by the determining unit, the PDU carrying the feedback information.

In a fourth possible implementation manner, according to the third possible implementation manner, the determining unit is specifically configured to determine, according to a moment when the receive end device receives the data, a quantity of times that the receive end device receives the data, and a time during which the receive end device processes the received data, a sending moment for sending a feedback.

In a fifth possible implementation manner, according to the third possible implementation manner, the determining unit is specifically configured to determine, according to a moment when the receive end device receives the data, a quantity of times that the receive end device receives the data, a time during which the receive end device processes the received data, and a feedback time window preconfigured by the receive end device, a sending time period for sending the feedback information.

In a sixth possible implementation manner, according to the fifth possible implementation manner, the sending unit is specifically configured to send the feedback information to the transmit end device at the first moment, within the sending time period, having a first resource, where the first resource is a resource that can be used to send the feedback information.

In a seventh possible implementation manner, according to the sixth aspect or either of the foregoing two possible implementation manners, the sending module is further configured to send, to the transmit end device, the first PDU that has data to be sent and that carries the feedback information.

According to a seventh aspect, embodiments provide a device for sending feedback information, including: a sending module, configured to send data to a base station; and a receiving module, configured to receive feedback information that is sent by the base station and that is scheduled by using a physical downlink control channel PDCCH scrambled with a radio network temporary identifier RNTI, where the feedback information is used to indicate whether the base station receives the data correctly.

In a first possible implementation manner, according to the seventh aspect, the device further includes: a grouping module and an acquiring module, where the grouping module is configured to perform grouping according to an identifier of user equipment, to obtain a group identifier; the acquiring module is configured to acquire, according to the group identifier obtained by the grouping module, a feedback information receiving parameter of a group to which the user equipment belongs, where the feedback information receiving parameter is used to identify that the user equipment receives, on an allocated resource, the feedback information that is sent by the base station; and the receiving module is further configured to receive the feedback information that is sent by the base station and that is scheduled, when the feedback information receiving parameter of the group to which the user equipment belongs is used, by using the PDCCH scrambled with one common RNTI.

In a second possible implementation manner, according to the first possible implementation manner, the acquiring module is further configured to acquire, according to the group identifier obtained by the grouping module, the feedback information receiving parameter of the user equipment, and an RNTI of the group to which the user equipment belongs, where the feedback information receiving parameter is used to identify that the user equipment receives, on an allocated resource, the feedback information that is sent by the base station; and the receiving module is further configured to receive the feedback information that is sent by the base station and that is scheduled, when the feedback information receiving parameter is used, by using the PDCCH scrambled with the RNTI of the group to which the user equipment belongs.

In a third possible implementation manner, according to the first possible implementation manner, the acquiring module is further configured to acquire, according to the group identifier, an RNTI of the group to which the user equipment belongs. The receiving module is further configured to receive the feedback information that is sent by the base station and that is scheduled, within a sending time period for sending a feedback, by using the PDCCH scrambled with the RNTI of the group to which the user equipment belongs, where the sending time period is a sending time period, for sending the feedback, determined after the base station processes the data sent by the user equipment.

In a fourth possible implementation manner, according to any one of the foregoing three possible implementation manners, the grouping module includes: a calculation unit and a determining unit. The calculation unit is configured to divide the identifier of the user equipment by a grouping quantity M, to obtain a remainder; and the determining unit is configured to use the remainder as the group identifier of the user equipment.

In a fifth possible implementation manner, with reference to the first aspect or any one of the foregoing four possible implementation manners, the feedback information includes: an identifier of at least one user equipment, at least one HARQ process ID, and N information bits, where the N information bits correspond to the HARQ process ID, and each of the information bits is used to denote whether the base station correctly receives data that is sent by the user equipment and that corresponds to a HARQ process ID.

According to an eighth aspect, embodiments provide a device for sending feedback information, including: a receiving module, configured to receive data sent by user equipment, where the data includes an identifier of the user equipment; a feedback information generation module, configured to generate feedback information according to the data that is sent by the user equipment and that is received by the receiving module, where the feedback information is used to identify whether the base station correctly receives the data sent by the user equipment; and a sending module, configured to send, to the user equipment, the feedback information scheduled by using a physical downlink control channel PDCCH scrambled with a radio network temporary identifier RNTI.

In a first possible implementation manner, according to the eighth aspect, the device further includes: a grouping module and an acquiring module, where the grouping module is configured to perform grouping according to the identifier, of the user equipment, in the data sent by the user equipment, to obtain a group identifier of the user equipment; the acquiring module is configured to acquire, according to the group identifier obtained by the grouping module, a feedback information receiving parameter of a group to which the user equipment belongs; and the sending module is further configured to send, to the user equipment according to the feedback information receiving parameter of the group to which the user equipment belongs, the feedback information scheduled by using the PDCCH scrambled with one common RNTI.

In a second possible implementation manner, according to the first possible implementation manner, the acquiring module is further configured to acquire, according to the group identifier obtained by the grouping module, an RNTI of the group to which the user equipment belongs and the feedback information receiving parameter; and the sending module is further configured to send, to the user equipment according to the feedback information receiving parameter of the user equipment, the feedback information scheduled by using the PDCCH scrambled with the RNTI of the group to which the user equipment belongs.

In a third possible implementation manner, according to the first possible implementation manner, the acquiring module is further configured to acquire, according to the group identifier, the RNTI of the group to which the user equipment belongs; and the sending module is further configured to send, to the user equipment, the feedback information that is scheduled, within a sending time period for sending a feedback, by using the PDCCH scrambled with the RNTI of the group to which the user equipment belongs, where the sending time period is a sending time period, for sending the feedback, determined after the base station processes the data sent by the user equipment.

In a fourth possible implementation manner, according to any one of the foregoing three possible implementation manners, the grouping module includes: a calculation unit and a determining unit, where the calculation unit is configured to divide the identifier of the user equipment by a grouping quantity M, to obtain a remainder; and the determining unit is configured to use the remainder as the group identifier of the user equipment.

In a fifth possible implementation manner, with reference to the eighth aspect or any one of the foregoing four possible implementation manners, the feedback information includes: an identifier of at least one user equipment, at least one HARQ process ID, and N information bits, where the N information bits correspond to the HARQ process ID, and each of the information bits is used to denote whether the base station correctly receives data that is sent by the user equipment and that corresponds to a HARQ process ID.

According to a ninth aspect, embodiments provide a device for sending feedback information. The device includes a sending module, configured to send uplink-downlink time configuration information to user equipment, where the user equipment supports a change in uplink-downlink time ratio allocation; and a receiving module, configured to receive feedback information sent by the user equipment, where the feedback information is used to identify whether the user equipment receives the uplink-downlink time configuration information sent by a base station.

In a first possible implementation manner, according to the ninth aspect, the receiving module is specifically configured to receive a media access control MAC layer PDU that is sent by the user equipment and that carries the feedback information.

In a second possible implementation manner, according to the ninth aspect, the receiving module is specifically configured to receive an enhanced scheduling request SR that is sent by the user equipment and that carries the feedback information.

In a third possible implementation manner, according to the ninth aspect, the receiving module is specifically configured to receive an enhanced downlink-data uplink-feedback ACK/NACK that is sent by the user equipment and that carries the feedback information.

In a fourth possible implementation manner, according to the ninth aspect, the device further includes: an allocation module, where the allocation module is configured to allocate, to the user equipment, a resource used to feed back whether the uplink-downlink time configuration information is received; and the receiving module is further configured to receive, on the resource allocated to the user equipment for the feedback, the feedback information sent by the user equipment.

In a fifth possible implementation manner, with reference to the ninth aspect or any one of the foregoing four possible implementation manners, the receiving module is further configured to: if the user equipment receives the uplink-downlink time configuration information sent by the base station, receive the feedback information sent by the user equipment; and/or if the user equipment does not receive the uplink-downlink time configuration information sent by the base station, receive the feedback information sent by the user equipment.

According to a tenth aspect, embodiments provide a device for sending feedback information, including: a receiving module, configured to receive uplink-downlink time configuration information sent by a base station, where the user equipment supports a change in uplink-downlink time ratio allocation; a feedback information generation module, configured to generate feedback information according to whether the receiving module receives the uplink-downlink time configuration information sent by the base station, where the feedback information is used to identify whether the user equipment receives the uplink-downlink time configuration information sent by the base station; and a sending module, configured to send the feedback information of the feedback information generation module to the base station.

In a first possible implementation manner, according to the tenth aspect, the feedback information generation module is configured to generate a media access control MAC layer PDU carrying the feedback information; and the sending module is configured to send, to the base station, the MAC PDU carrying the feedback information.

In a second possible implementation manner, according to the tenth aspect, the feedback information generation module is further configured to generate an enhanced scheduling request SR carrying the feedback information; and the sending module is further configured to send, to the base station, the enhanced SR carrying the feedback information.

In a third possible implementation manner, according to the tenth aspect, the feedback information generation module is further configured to generate an enhanced downlink-data uplink-feedback ACK/NACK carrying the feedback information; and the sending module is further configured to send, to the base station, the enhanced downlink-data uplink-feedback ACK/NACK carrying the feedback information.

In a fourth possible implementation manner, according to the tenth aspect, the sending module is further configured to send the feedback information to the base station on a resource that is allocated by the base station to the user equipment and that is used to feed back whether the uplink-downlink time configuration information is received.

In a fifth possible implementation manner, with reference to the tenth aspect or any one of the foregoing four possible implementation manners, the sending module is further configured to: if the user equipment receives the uplink-downlink time configuration information, send the feedback information to the base station; and/or, if the user equipment does not receive the uplink-downlink time configuration information, send the feedback information to the base station.

According to an eleventh aspect, embodiments provide a system for sending feedback information, including: a receive end device, and the device according to the sixth aspect or any possible implementation manner of the sixth aspect above; or the device according to the seventh aspect or any possible implementation manner of the seventh aspect above, and the device according to the eighth aspect or any possible implementation manner of the eighth aspect above; or the device according to the ninth aspect or any possible implementation manner of the ninth aspect above, and the device according to the tenth aspect or any possible implementation manner of the tenth aspect above.

In the method, device, and system for sending feedback information provided in the embodiments of the present invention, feedback information is carried in a MAC PDU or feedback information is carried in an RLC PDU, or feedback information is scheduled by using a PDCCH scrambled with an RNTI, to enable a receive end to transmit feedback information without using a PUCCH/PHICH feedback channel, so as to improve system efficiency; further, user equipment gives a feedback in response to uplink-downlink time configuration information sent by a base station, so that the base station and the user equipment have consistent uplink-downlink time configuration information, thereby avoiding disordered scheduling between the base station and the user equipment, so as to achieve flexible adjustment of an uplink-downlink time configuration according to different services.

### BRIEF DESCRIPTION OF THE DRAWINGS

For a more complete understanding of the present invention, and the advantages thereof, reference is now made to the following descriptions taken in conjunction with the accompanying drawings, in which:

To describe the technical solutions in the embodiments of the present invention more clearly, the following briefly introduces the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a schematic diagram of a method for sending feedback information according to an embodiment of the present invention;

FIG. 2 is a schematic diagram of another method for sending feedback information according to an embodiment;

FIG. 3 is a schematic diagram of another method for sending feedback information according to an embodiment;

FIG. 4 is a schematic diagram of another method for sending feedback information according to an embodiment;

FIG. 5 is a schematic diagram of a method for sending, by user equipment, a MAC PDU carrying feedback information according to an embodiment;

FIG. 6 is a schematic diagram of a method for sending, by user equipment, an RLC PDU carrying feedback information according to an embodiment;

FIG. 7 is a schematic diagram of a method for sending group feedback information by a base station according to an embodiment;

FIG. 8 is a schematic diagram of a device for sending feedback information according to an embodiment;

FIG. 9 is a schematic diagram of another device for sending feedback information according to an embodiment;

FIG. 10 is a schematic diagram of another device for sending feedback information according to an embodiment;

FIG. 11 is a schematic diagram of another device for sending feedback information according to an embodiment;

FIG. 12 is a schematic diagram of another device for sending feedback information according to an embodiment;

FIG. 13 is a schematic diagram of another device for sending feedback information according to an embodiment;

FIG. 14 is a schematic diagram of another device for sending feedback information according to an embodiment;

FIG. 15 is a schematic diagram of another device for sending feedback information according to an embodiment;

FIG. 16 is a schematic diagram of another device for sending feedback information according to an embodiment;

FIG. 17 is a schematic diagram of another device for sending feedback information according to an embodiment;

FIG. 18 is a schematic diagram of another device for sending feedback information according to an embodiment;

FIG. 19 is a schematic diagram of a physical apparatus for sending feedback information according to an embodiment;

FIG. 20 is a schematic diagram of another physical apparatus for sending feedback information according to an embodiment;

FIG. 21 is a schematic diagram of another physical apparatus for sending feedback information according to an embodiment;

FIG. 22 is a schematic diagram of another physical apparatus for sending feedback information according to an embodiment; and

FIG. 23 is a schematic diagram of another physical apparatus for sending feedback information according to an embodiment.

### DETAILED DESCRIPTION OF ILLUSTRATIVE EMBODIMENTS

The following clearly describes the technical solutions in the embodiments with reference to the accompanying drawings in the embodiments. Apparently, the described embodiments are merely some but not all of the embodiments of the present invention. All other embodiments obtained by persons of ordinary skill in the art based on the embodiments of the present invention without creative efforts shall fall within the protection scope of the present invention.

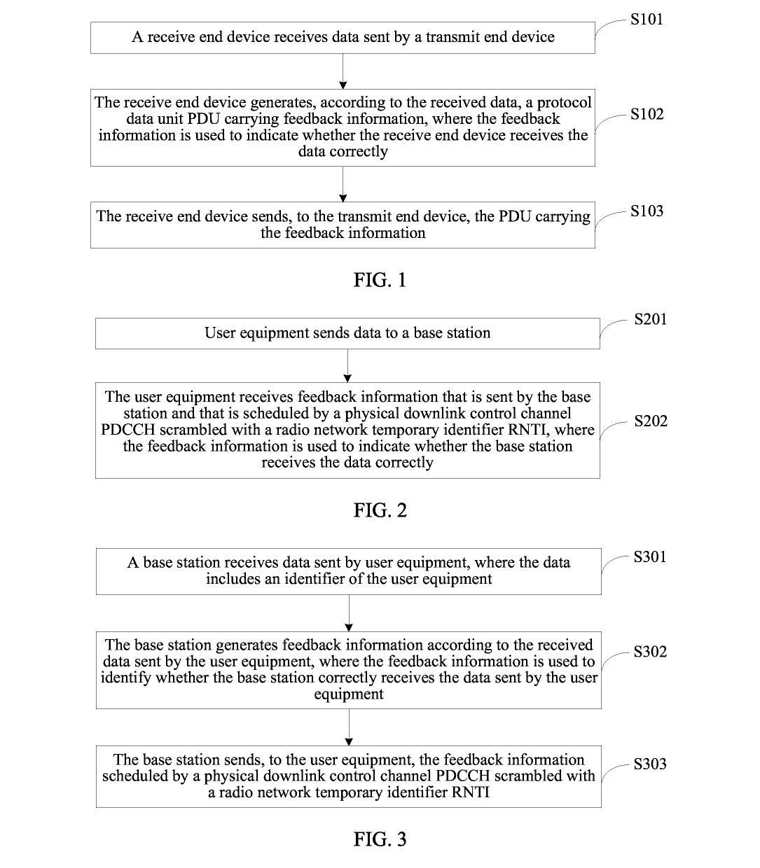

An embodiment provides a method for sending feedback information. If a receive end device is a base station, a transmit end device is user equipment, and the method for sending feedback information provided in this embodiment involves a downlink feedback for uplink data. If a receive end device is user equipment, a transmit end device is a base station, and the method for sending feedback information provided in this embodiment involves an uplink feedback for downlink data. The method for sending feedback information is described below in detail, and as shown in FIG. 1, specific steps include the following.

S101: A receive end device receives data sent by a transmit end device.

S102: The receive end device generates, according to the received data, a protocol data unit PDU carrying feedback information, where the feedback information is used to indicate whether the receive end device receives the data correctly.

The protocol data unit (PDU) that is generated by the receive end device according to the received data and that carries the feedback information may be a media access control (MAC) layer PDU, or may be a radio link control (RLC) layer PDU, and is certainly not limited thereto.

For a PDU that is generated at a MAC layer and that carries the feedback information, according to a format of the MAC PDU, two different formats for carrying the feedback information may be formed: In one feedback format, a bit in any sub-header (sub-header) of the MAC PDU is used to carry the feedback information about whether the data is received correctly; and in the other feedback format, a control information element (CE) in the MAC PDU is used to carry the feedback information about whether the data is received correctly, where the MAC PDU includes a logical channel identifier LCID) used to denote that the MAC CE is used to carry the feedback information.

That a bit in any sub-header of the MAC PDU is used to carry the feedback information about whether the data is received correctly includes: One reserved (R for short) bit in a first sub-header of the MAC PDU may be used to indicate the feedback information about whether the data is received correctly, which is certainly not limited thereto.

That a control information element CE in the MAC PDU is used to carry the feedback information about whether the data is received correctly includes: The MAC CE includes N information bits, and the information bits correspond to HARQ process IDs; or the MAC CE includes N information bits and one HARQ process ID, where any one of the N information bits corresponds to the HARQ process ID, and the remaining N−1 information bits correspond to other HARQ process IDs; where each of the information bits is used to denote whether the receive end device correctly receives data that is sent by the transmit end device and that corresponds to a HARQ process ID.

Optionally, that the MAC CE includes N information bits, and the information bits correspond to HARQ process IDs may be: The first information bit corresponds to a HARQ process whose process ID is 1, the second information bit corresponds to a HARQ process whose process ID is 2, and the like; or may be: the first information bit corresponds to the first HARQ process (not necessarily a HARQ process whose process ID is 1) after a previous time of feedback, the second information bit corresponds to a second HARQ process after the previous time of feedback, and the like; a manner in which the information bits correspond to HARQ process IDs is not limited to the manner described above.

Alternatively, optionally, that the MAC CE includes N information bits and one HARQ process ID, where any one of the N information bits corresponds to the HARQ process ID, and the remaining N−1 information bits correspond to other HARQ process IDs may be: the first information bit corresponds to a HARQ process identified by the foregoing HARQ process ID, the second information bit corresponds to a HARQ process identified by the foregoing HARQ process ID plus 1, and the like; or may be: the first information bit corresponds to a HARQ process identified by the foregoing HARQ process ID plus 1, the second information bit corresponds to a HARQ process identified by the HARQ process ID plus 2, and the like. A manner in which any one of the N information bits corresponds to the HARQ process ID, and the remaining N−1 information bits correspond to other HARQ process IDs is not limited to the manner described above.

For each information bit, 0 may denote that data is not correctly received (Negative Acknowledgement, NACK for short), 1 may denote that data is correctly received (Acknowledgement, ACK for short); or 0 may denote ACK, and 1 may denote NACK.

For a PDU that is generated at an RLC layer and that carries the feedback information, according to a format of the RLC PDU, the generated PDU carrying the feedback information includes: a data identifier and N information bits, and the N information bits correspond to the data received by the receive end device; or a control identifier, a control content identifier, and N information bits, and the N information bits correspond to control information received by the receive end device; where each of the information bits is used to denote whether the receive end device correctly receives data that is sent by the transmit end device and that corresponds to a process ID.

Specifically, that the N information bits correspond to control information received by the receive end device may be: the first information bit corresponds to the first RLC PDU after a previous time of feedback, the second information bit corresponds to the second RLC PDU after the previous time of feedback, and the like; certainly, a manner in which the N information bits correspond to the receive end device the received control information is not limited to the manner described above.

For each information bit, 0 may denote NACK, and 1 may denote ACK; or 0 may denote ACK, and 1 may denote NACK.

S103: The receive end device sends, to the transmit end device, the PDU carrying the feedback information.

The receive end device may be configured to send a feedback at a specific sending moment or within a specific sending time period.

Specifically, the sending, by the receive end device to the transmit end device, the PDU carrying the feedback information includes: determining a sending time of the PDU carrying the feedback information; and sending, to the transmit end device at the sending time, the PDU carrying the feedback information.

In a case in which it is determined that the sending time of the PDU carrying the feedback information is a sending moment, optionally, a sending moment of a feedback is determined according to a moment when the receive end device receives the data, a quantity of times that the receive end device receives the data, and a time during which the receive end device processes the received data.

Alternatively, optionally, a sending moment of a feedback is determined according to a first formula, where the first formula is: T=t+n−1+k, where T denotes the sending moment of the feedback, t denotes a moment when the receive end device receives the data, n denotes a quantity of times that the receive end device repeats the received data, and k denotes a time during which the receive end device processes the received data.

In a case in which it is determined that the sending time of the PDU carrying the feedback information is a sending time period, optionally, a sending time period for sending the feedback information is determined according to a moment when the receive end device receives the data, a quantity of times that the receive end device receives the data, a time during which the receive end device processes the received data, and a feedback time window preconfigured by the receive end device.

Alternatively, optionally, a start moment T1 of a sending time period is determined according to a second formula, and an end moment T2 of the sending time period is determined according to the third formula, where the second formula is: T1=t+n−1+k, and the third formula is: T2=t+n−1+k+w, where t denotes a moment when the receive end device receives the data, n denotes a quantity of times that the receive end device repeats the received data, k denotes a time during which the receive end device processes the received data, and W denotes a feedback time window preconfigured by the receive end device.

Further, in a process of determining a feedback time period, the feedback time window preconfigured by the receive end device may be a fixed value configured initially.

If the receive end device is user equipment, and the transmit end device is a base station, the feedback time window preconfigured by the receive end device may be a fixed value configured initially, or may be configured for the receive end device by the transmit end device by using a radio resource control RRC message.

Specifically, if the receive end device is a base station, and the transmit end device is user equipment, the feedback time preconfigured by the receive end device is a fixed value configured initially. If the receive end device is user equipment, and the transmit end device is a base station, the feedback time window preconfigured by the user equipment may be a fixed value configured initially, or may be configured by the base station by using an RRC message.

Further, within the sending time period for sending the feedback information, the sending, to the transmit end device at the sending time, the PDU carrying the feedback information includes: sending, by the receive end device, the feedback information to the transmit end device at the first moment, within the sending time period, having a first resource, where the first resource is a resource that can be used to send the feedback information.

Specifically, the receive end device send, within the feedback time window for sending a feedback and on the first subframe having an uplink scheduling grant, the feedback information to the transmit end device.

Further, in a case without a limit of a sending moment or a sending time period for sending a feedback, the receive end device may add the feedback information to the first MAC PDU having uplink data to be sent and send the first MAC PDU to the transmit end device.

Further, according to step S102 and step S103, at a feedback moment for sending a feedback or within a feedback time period for sending a feedback, where the feedback moment or the feedback time period needs to be determined by the receive end device, if there is an uplink MAC PDU to send, a bit of any sub-header in the MAC PDU may be used to carry the feedback information, or if there is no uplink MAC PDU to send, the feedback information may be carried in a CE in the first MAC PDU having uplink data to be sent.

In the method for sending feedback information provided in this embodiment, feedback information is carried in a MAC PDU or feedback information is carried in an RLC PDU, to enable a receive end to transmit feedback information without using a PUCCH/PHICH feedback channel, so as to improve system efficiency.

An embodiment provides a method for sending feedback information. As shown in FIG. 2, an execution body is user equipment, and specific steps include the following.

S201: User equipment sends data to a base station.

S202: The user equipment receives feedback information that is sent by the base station and that is scheduled by using a physical downlink control channel PDCCH scrambled with a radio network temporary identifier RNTI, where the feedback information is used to indicate whether the base station receives the data correctly.

The feedback information includes: an identifier of at least one user equipment, one HARQ process ID, and N information bits, where the N information bits correspond to the HARQ process ID, and each of the information bits is used to denote whether the base station correctly receives data that is sent by the user equipment and that corresponds to a HARQ process ID.

Specifically, that the N information bits correspond to the HARQ process ID includes: the first information bit corresponds to a process denoted by the foregoing HARQ process ID, the second information bit corresponds to a process denoted by the foregoing HARQ process ID plus 1, and the like; or may be: the first information bit corresponds to a HARQ process identified by the foregoing HARQ process ID plus 1, the second information bit corresponds to a HARQ process identified by the HARQ process ID plus 2, and the like. A manner in which the N information bits correspond to the HARQ process ID is not limited to the manners described above.

It should be noted that, after a HARQ process ID corresponding to the i^{th} information bit of the N information bits reaches a maximum process number, a HARQ process ID following the maximum HARQ process ID is changed to be a HARQ process whose process ID is 0.

For each information bit, 0 may denote NACK, and 1 may denote ACK; or 0 may denote ACK, and 1 may denote NACK.

Optionally, before step S201, the method further includes: performing, by the user equipment, grouping according to an identifier of the user equipment, to obtain a group identifier; and obtaining, according to the group identifier, a feedback information receiving parameter of a group to which the user equipment belongs, where the feedback information receiving parameter is used to identify that the user equipment receives, on an allocated resource, the feedback information that is sent by the base station.

Further, step S202 is specifically: receiving, by the user equipment, the feedback information that is sent by the base station and that is scheduled, when the feedback information receiving parameter of the group to which the user equipment belongs is used, by using the PDCCH scrambled with one common RNTI.

The identifier of the user equipment may be an International Mobile Subscriber Identity (IMSI), or may be a temporary identity (TMSI), or may be a cell radio network temporary identifier (C-RNTI).

Specifically, the performing, by the user equipment, grouping according to an identifier of the user equipment, to obtain a group identifier includes: dividing, by the user equipment, the identifier of the user equipment by a grouping quantity M, to obtain a remainder; and using the remainder as the group identifier of the user equipment.

The grouping quantity M is configured for the user equipment by the base station in a broadcast manner, or the grouping quantity M is initially configured for the user equipment.

Specifically, according to the identifier of the user equipment modulo M, the user equipment obtains an identifier of a user equipment group to which the user equipment belongs, where sequence numbers of user equipment groups are from 0 to M−1. The user equipment obtains, according to the identifier of the user equipment group to which the user equipment belongs, a feedback information receiving parameter of the user equipment, where the feedback information receiving parameter is used to denote at what time and on what resource the user equipment receives the feedback information sent by the base station. Therefore, the user equipment receives the feedback information that is sent by the base station and that is scheduled, when the feedback information receiving parameter of the group to which the user equipment belongs is used, by using the PDCCH scrambled with the one common RNTI.

Alternatively, optionally, before step S201, the method further includes: performing, by the user equipment, grouping according to an identifier of the user equipment, to obtain a group identifier; and obtaining, according to the group identifier, a feedback information receiving parameter of the user equipment, and an RNTI of a group to which the user equipment belongs, where the feedback information receiving parameter is used to identify that the user equipment receives, on an allocated resource, the feedback information that is sent by the base station.

Further, step S202 is specifically: receiving, by the user equipment, the feedback information that is sent by the base station and that is scheduled, when the feedback information receiving parameter is used, by using the PDCCH scrambled with the RNTI of the group to which the user equipment belongs.

The identifier of the user equipment may be an IMSI, or may be a temporary identity TMSI, or may be a cell radio network temporary identifier C-RNTI.

Specifically, the performing, by the user equipment, grouping according to an identifier of the user equipment, to obtain a group identifier includes: dividing, by the user equipment, the identifier of the user equipment by a grouping quantity M, to obtain a remainder; and using the remainder as the group identifier of the user equipment.

The grouping quantity M is configured for the user equipment by the base station in a broadcast manner, or the grouping quantity M is initially configured for the user equipment.

Specifically, according to the identifier of the user equipment modulo M, the user equipment obtains an identifier of a user equipment group to which the user equipment belongs, where sequence numbers of user equipment groups are from 0 to M−1. The user equipment obtains, according to the identifier of the user equipment group to which the user equipment belongs, a feedback information receiving parameter of the user equipment, and an RNTI of the group to which the user equipment belongs, where the feedback information receiving parameter is used to denote at what time and on what resource the user equipment receives the feedback information sent by the base station. Therefore, the user equipment receives the feedback information that is sent by the base station and that is scheduled, when the feedback information receiving parameter is used, by using the PDCCH scrambled with the RNTI of the group to which the user equipment belongs.

Alternatively, optionally, before step S201, the method further includes: performing, by the user equipment, grouping according to an identifier of the user equipment, to obtain a group identifier; and obtaining, according to the group identifier, an RNTI of a group to which the user equipment belongs.

Further, step S202 is specifically: receiving, by the user equipment, the feedback information that is sent by the base station and that is scheduled, within a sending time period for sending a feedback, by using the PDCCH scrambled with the RNTI of the group to which the user equipment belongs, where the sending time period is a sending time period, for sending the feedback, determined after the base station processes the data sent by the user equipment.

The identifier of the user equipment may be an IMSI, or may be a temporary identity TMSI, or may be a cell radio network temporary identifier C-RNTI.

Specifically, the performing, by the user equipment, grouping according to an identifier of the user equipment, to obtain a group identifier includes: dividing, by the user equipment, the identifier of the user equipment by a grouping quantity M, to obtain a remainder; and using the remainder as the group identifier of the user equipment.

Further, the grouping quantity M is configured for the user equipment by the base station in a broadcast manner, or the grouping quantity M is initially configured for the user equipment.

Specifically, according to the identifier of the user equipment modulo M, the user equipment obtains an identifier of a user equipment group to which the user equipment belongs, where sequence numbers of user equipment groups are from 0 to M−1. The user equipment obtains, according to the identifier of the user equipment group to which the user equipment belongs, an RNTI of the group to which the user equipment belongs. Therefore, the user equipment receives the feedback information that is sent by the base station and that is scheduled, within a sending time period for sending a feedback, by using the PDCCH scrambled with the RNTI of the group to which the user equipment belongs, where the sending time period is a sending time period, for sending the feedback, determined after the base station processes the data sent by the user equipment.

In the method for sending feedback information provided in this embodiment of the present invention, for a downlink feedback for uplink data, a base station uses a group feedback manner, and feedback information is scheduled by using a PDCCH scrambled with an RNTI, so that feedback information can be transmitted without using a PUCCH/PHICH feedback channel, thereby improving system efficiency.

An embodiment provides a method for sending feedback information. As shown in FIG. 3, an execution body is a base station, and specific steps include the following.

S301: A base station receives data sent by user equipment, where the data includes an identifier of the user equipment.

S302: The base station generates feedback information according to the received data sent by the user equipment, where the feedback information is used to identify whether the base station correctly receives the data sent by the user equipment.

The feedback information includes: an identifier of at least one user equipment, at least one HARQ process ID, and N information bits, where the N information bits correspond to the HARQ process ID, and each of the information bits is used to denote whether the base station correctly receives the data that is sent by the user equipment and that corresponds to a HARQ process ID.

Specifically, that the N information bits correspond to the HARQ process ID includes: the first information bit corresponds to a process denoted by the foregoing HARQ process ID, the second information bit corresponds to a process denoted by the foregoing HARQ process ID plus 1, and the like; or may be: the first information bit corresponds to a HARQ process identified by the foregoing HARQ process ID plus 1, the second information bit corresponds to a HARQ process identified by the HARQ process ID plus 2, and the like. A manner in which the N information bits correspond to the HARQ process ID is not limited to the manners described above.

It should be noted that, after a HARQ process ID corresponding to the i^{th} information bit of the N information bits reaches a maximum process number, a HARQ process ID following the maximum HARQ process ID is changed to be a HARQ process whose process ID is 0.

For each information bit, 0 may denote NACK, and 1 may denote positive ACK; or 0 may denote ACK, and 1 may denote NACK.

S303: The base station sends, to the user equipment, the feedback information scheduled by using a physical downlink control channel PDCCH scrambled with a radio network temporary identifier RNTI.

Optionally, before step S301, the base station is preconfigured with: one common RNTI, a grouping quantity M of user equipments, and a feedback information receiving parameter of a group to which the user equipment belongs.

According to the foregoing preconfiguration of the base station, after step S302, the method further includes: performing, by the base station, grouping according to the identifier, of the user equipment, in the data sent by the user equipment, to obtain a group identifier of the user equipment; and obtaining, according to the group identifier, the feedback information receiving parameter of the group to which the user equipment belongs.

The identifier of the user equipment may be an IMSI, or may be a TMSI, or may be a C-RNTI.

Specifically, the performing, by the user equipment, grouping according to the identifier of the user equipment, to obtain a group identifier includes: dividing, by the user equipment, the identifier of the user equipment by the grouping quantity M, to obtain a remainder; and using the remainder as the group identifier of the user equipment.

That is, according to the identifier of the user equipment modulo M, the base station obtains an identifier of a user equipment group to which the user equipment belongs, where sequence numbers of user equipment groups are from 0 to M−1, so as to further obtain the feedback information receiving parameter of the group to which the user equipment belongs.

Further, step S303 is specifically: sending, by the base station to the user equipment according to the feedback information receiving parameter of the group to which the user equipment belongs, the feedback information scheduled by using the PDCCH scrambled with one common RNTI.

Alternatively, optionally, before step S301, that is, before the base station receives the data sent by the user equipment, the base station is preconfigured with: a grouping quantity M of user equipments, M RNTIs, and a feedback information receiving parameter of the user equipment. According to the foregoing preconfiguration of the base station, after step S302, the method further includes: performing, by the base station, grouping according to the identifier, of the user equipment, in the data sent by the user equipment, to obtain a group identifier of the user equipment; and obtaining, according to the group identifier, an RNTI of the group to which the user equipment belongs and the feedback information receiving parameter.

The identifier of the user equipment may be an IMSI, or may be a TMSI, or may be a C-RNTI.

Specifically, the performing, by the user equipment, grouping according to the identifier of the user equipment, to obtain a group identifier includes: dividing, by the user equipment, the identifier of the user equipment by a grouping quantity M, to obtain a remainder; and using the remainder as the group identifier of the user equipment.

That is, according to the identifier of the user equipment modulo M, the base station obtains an identifier of a user equipment group to which the user equipment belongs, where sequence numbers of user equipment groups are from 0 to M−1, so as to further obtain the RNTI of the group of the user equipment, and the feedback information receiving parameter of the user equipment.

Further, step S303 is specifically: sending, by the base station to the user equipment according to the feedback information receiving parameter of the user equipment, the feedback information scheduled by using the PDCCH scrambled with the RNTI of the group to which the user equipment belongs.

Alternatively, optionally, before step S301, the base station is preconfigured with: a grouping quantity M of user equipments, and M RNTIs, where groups of the user equipments correspond to the RNTIs one by one.

According to the foregoing preconfiguration of the base station, after step S302, the method further includes: performing, by the base station, grouping according to the identifier, of the user equipment, in the data sent by the user equipment, to obtain a group identifier of the user equipment; and obtaining, according to the group identifier, an RNTI of the group to which the user equipment belongs.

The identifier of the user equipment may be an IMSI, or may be a TMSI, or may be a C-RNTI.

Specifically, the performing, by the user equipment, grouping according to the identifier of the user equipment, to obtain a group identifier includes: dividing, by the user equipment, the identifier of the user equipment by the grouping quantity M, to obtain a remainder; and using the remainder as the group identifier of the user equipment.

That is, according to the identifier of the user equipment modulo M, the base station obtains an identifier of a user equipment group to which the user equipment belongs, where sequence numbers of user equipment groups are from 0 to M−1, so as to further obtain the RNTI of the group of the user equipment.

Further, step S303 is specifically: sending, by the base station to the user equipment, the feedback information that is scheduled, within a sending time period for sending a feedback, by using the PDCCH scrambled with the RNTI of the group to which the user equipment belongs, where the sending time period is a sending time period, for sending the feedback, determined after the base station processes the data sent by the user equipment.

Exemplarily, it is assumed that first user equipment sends, on the first subframe, first data to the base station, and after processing, the base station may send, on any of the fifth subframe to the eighth subframe after the first subframe, feedback information to the first data; second user equipment sends, on the second subframe, second data to the base station, and after processing, the base station may send, on any of the sixth subframe to the ninth subframe after the second subframe, the feedback information of the second data. Therefore, the base station may group the first user equipment and the second user equipment into a same user equipment group according to the received first data and second data, so that the base station may send, to the user equipment, feedback information that is scheduled, within a time period for sending a feedback, by using a PDCCH scrambled with an RNTI of the group to which the user equipment belongs.

It should be noted that Embodiment 1, Embodiment 2, and Embodiment 3 belong to one general inventive concept, and in Embodiment 1, feedback information is carried in a MAC PDU or an RLC PDU, and an uplink data channel is used to send the MAC PDU or RLC PDU carrying the feedback information; in Embodiment 2 and Embodiment 3, a base station uses a group feedback mechanism for data sent by user equipment, and feedback information is scheduled by using a PDCCH scrambled with an RNTI. In Embodiment 1 to Embodiment 3 above, feedback information is transmitted without using a PUCCH/PHICH feedback channel, and therefore Embodiment 1 to Embodiment 3 belong to one general inventive concept.

In the method for sending feedback information provided in this embodiment, for a downlink feedback for uplink data, a base station uses a group feedback manner, and feedback information is scheduled by using a PDCCH scrambled with an RNTI, so that feedback information can be transmitted without using a PUCCH/PHICH feedback channel, thereby improving system efficiency.

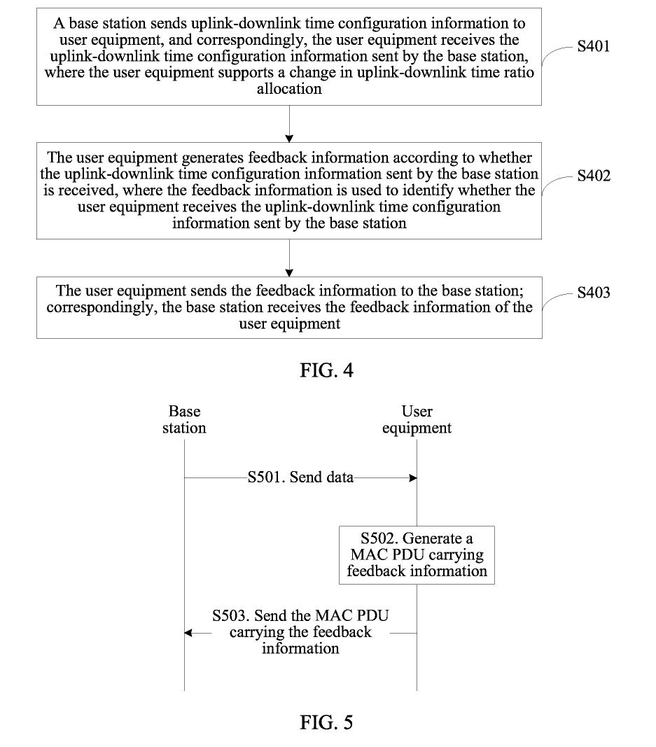

An embodiment provides a method for sending feedback information. As shown in FIG. 4, specific steps include the following.

S401: A base station sends uplink-downlink time configuration information to user equipment, and correspondingly, the user equipment receives the uplink-downlink time configuration information sent by the base station, where the user equipment supports a change in uplink-downlink time ratio allocation.

The uplink-downlink time configuration information may be an index of an uplink-downlink time configuration, or may be information about a change in an uplink-downlink time configuration, and is certainly not limited thereto.

S402: The user equipment generates feedback information according to whether the uplink-downlink time configuration information sent by the base station is received, where the feedback information is used to identify whether the user equipment receives the uplink-downlink time configuration information sent by the base station.

Specifically, the user equipment may generate the feedback information in a case in which the uplink-downlink time configuration information is received; and/or the user equipment may generate the feedback information in a case in which the uplink-downlink time configuration information is not received.

Optionally, the feedback information may be generated in a case in which some user equipments of all user equipments receive the uplink-downlink time configuration information sent by the base station.

Alternatively, optionally, the feedback information may be generated in a case in which some user equipments of all user equipments do not receive the uplink-downlink time configuration information sent by the base station.

Alternatively, optionally, the feedback information is generated regardless of whether the user equipment receives the uplink-downlink time configuration information sent by the base station.

Specifically, the user equipment may generate a media access control MAC layer PDU carrying the feedback information.

Optionally, a bit in any sub-header of the MAC PDU may be used to carry the feedback information about whether the user equipment receives the uplink-downlink time configuration information sent by the base station.

Alternatively, optionally, a logical channel identifier LCID of the MAC PDU may be used to identify the feedback information about whether the user equipment receives the uplink-downlink time configuration information sent by the base station.

Alternatively, optionally, a control information element CE in the MAC PDU may be used to carry the feedback information about whether the user equipment receives the uplink-downlink time configuration information sent by the base station, where the MAC PDU includes a logical channel identifier LCID used to identify that the MAC CE is used to carry the feedback information.

Exemplarily, one R bit in the MAC PDU may be used to carry the feedback information about whether the user equipment receives the uplink-downlink time configuration information sent by the base station; or one LCID may be added to the MAC PDU, where the LCID is used to identify the feedback information about whether the user equipment receives the uplink-downlink time configuration information sent by the base station; or one LCID and a MAC CE corresponding to the LCID may be added to the MAC PDU, where the LCID is used to denote that the MAC CE is used to carry the feedback information, and the MAC CE carries the feedback information, where 0 or 1 may be used to identify the feedback information, 0 may denote the feedback information about that the user equipment receives the uplink-downlink time configuration information sent by the base station, and 1 may denote the feedback information about that the user equipment does not receive the uplink-downlink time configuration information sent by the base station; or 0 may denote the feedback information about that the user equipment does not receive the uplink-downlink time configuration information sent by the base station, and 1 may denote the feedback information about that the user equipment receives the uplink-downlink time configuration information sent by the base station.

Specifically, the user equipment may generate an enhanced scheduling request (SR) carrying the feedback information and send the enhanced SR to the base station.

The enhanced SR not only can carry the scheduling request, but also can carry the feedback information about whether the user equipment receives the uplink-downlink configuration information sent by the base station.

Specifically, the user equipment may generate an enhanced downlink-data uplink-feedback (Acknowledgement/Negative Acknowledgement, ACK/NACK) carrying the feedback information and send the enhanced ACK/NACK to the base station.

The enhanced ACK/NACK not only can carry the feedback information generated by the user equipment for the data sent by the base station, but also can carry the feedback information about whether the user equipment receives the uplink-downlink configuration information sent by the base station.

S403: The user equipment sends the feedback information to the base station; and correspondingly, the base station receives the feedback information sent by the user equipment.

Optionally, the user equipment may send, to the base station on a physical uplink shared channel PUSCH channel, a MAC PDU carrying the feedback information.

Alternatively, optionally, before step S401, the base station may allocate, to the user equipment, a resource used to feed back whether the uplink-downlink time configuration information is received, so that the user equipment sends the feedback information to the base station on the resource that is allocated by the base station to the user equipment and that is used to feed back whether the uplink-downlink time configuration information is received.

Further, when the base station sends, to at least one user equipment, information about a change in an uplink-downlink time configuration, if the user equipment receives the information, about a change in an uplink-downlink time configuration, sent by the base station, the user equipment generates feedback information and sends the feedback information to the base station; if the user equipment does not receive the information, about a change in an uplink-downlink time configuration, sent by the base station, the user equipment sends and receives data according to the previous uplink-downlink time configuration information sent by the base station.

In the method for sending feedback information provided in this embodiment, user equipment adds, to a MAC PDU, or an enhanced scheduling request, or an enhanced downlink-data uplink-feedback ACK/NACK, feedback information about whether the user equipment receives uplink-downlink time configuration information sent by a base station, or a base station directly allocates, to user equipment, a resource used for a feedback, so that the base station and the user equipment have consistent uplink-downlink time configuration information, thereby avoiding disordered scheduling between the base station and the user equipment, so as to achieve flexible adjustment of an uplink-downlink time configuration according to different services.

### Embodiment 1

This embodiment provides a method for sending feedback information. The method for sending feedback information is described in detail by using an example in which a base station sends data to user equipment, and the user equipment needs to send feedback information to the base station at a sending moment or in a sending time period for sending feedback information, that is, by using an uplink feedback for downlink data as an example. As shown in FIG. 5, specific steps include the following.

Step 501: A base station sends data to UE.

The base station indicates, on a physical downlink control channel (PDCCH for short), that a downlink resource allocated to UE is on a downlink shared channel (DL-SCH for short), and the base station sends the data on the downlink resource allocated to the UE.

Step 502: The UE receives the data sent by the base station, determines whether the data is correctly decoded, and generates a MAC PDU carrying feedback information.

In the generated MAC PDU carrying the feedback information, a bit in any sub-header of the MAC PDU is used to carry the feedback information about whether the data is received correctly; a bit in a first sub-header of the MAC PDU may be used to carry the feedback information about whether the data is received correctly, or a bit in another sub-header of the MAC PDU may be used to carry the feedback information about whether the data is received correctly; and the bit may be a reserved bit in any sub-header of the MAC PDU, which is certainly not limited thereto.

Exemplarily, one R bit in a first sub-header of the MAC PDU is used to indicate ACK/NACK, where 1 may denote ACK, and 0 may denote NACK; or 1 may denote NACK, and 0 may denote ACK.

According to the received data, the UE needs to determine whether the data is correctly decoded, and the UE needs a particular processing time for the received data. Different UEs may need a same processing time or different processing times for received data.

Step 503: The UE sends, to the base station, the generated MAC PDU carrying the feedback information.

Specifically, the UE may send, to the base station at a sending moment for sending a feedback or within a sending time period for sending a feedback, the generated MAC PDU carrying the feedback information, so that the base station determines, according to the received feedback information, whether the sent data is correctly received by the UE.

The UE may determine, according to a sending manner in which the base station sends the downlink data, the sending moment or the sending time period for sending the feedback information, and the sending manner may be that the base station resends data continuously, or may be that the base station continuously sends different data, and is certainly not limited thereto.

Exemplarily, it is assumed that a quantity of times that the base station repeatedly sends data continuously is n, a moment when the UE receives the data on a specified downlink resource is t, and a processing time of the UE for the received data is k; in this case, the UE determines that the sending moment for sending the feedback is t+N−1+k, where the sending moment is a sending moment for sending the feedback information by the UE for data that is sent repeatedly by the base station and that is received by the UE for the first time, and a quantity of times of repeatedly sending a feedback is the same as a quantity of times of repeatedly sending downlink data.

Exemplarily, it is assumed that the UE initially configures a feedback time window w fixedly; in this case, the UE determines that the sending time period for sending the feedback is from t+N−1+k to t+N−1+k+w, and within the sending time period, the feedback information is sent in the first subframe that is allocated by the base station to the user equipment and that is used for uplink data transmission.

In the method for sending feedback information provided in this embodiment of the present invention, a bit of any sub-header in a MAC PDU is used to carry feedback information, to enable a receive end to transmit feedback information without using a PUCCH/PHICH feedback channel, so as to improve system efficiency.

### Embodiment 2

This embodiment provides a method for sending feedback information, and same as Embodiment 1, an uplink feedback for downlink data is used as an example. In this embodiment, for specific steps, reference may be made to steps 501 to 503 in Embodiment 1, and a difference from Embodiment 1 lies in that UE does not need to determine a sending moment or a sending time period for sending a feedback, and a CE in the first uplink MAC PDU is used to carry feedback information.

In this embodiment, one new MAC CE in a MAC PDU is used to carry feedback information, where a LCID in a sub-header corresponding to the newly added MAC CE in the MAC PDU is used as an indication of the new MAC CE, so as to identify that the new MAC CE is used to carry the feedback information; the MAC CE includes N bits of feedback information, where 0 denotes NACK, and 1 denotes ACK; and the first bit corresponds to a HARQ process whose process ID is 1, a second bit corresponds to a HARQ process whose process ID is 2, and the like.

In the method for sending feedback information provided in this embodiment, a control information element in a MAC PDU is used to carry feedback information, to enable a receive end to transmit feedback information without using a PUCCH/PHICH feedback channel, so as to improve system efficiency.

### Embodiment 3

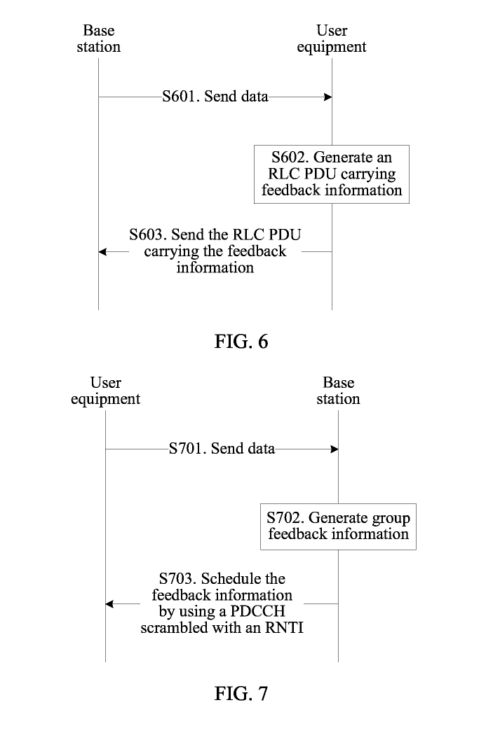

This embodiment provides a method for sending feedback information. Similarly, an uplink feedback for downlink data is used as an example, and a difference from Embodiment 1 lies in that a MAC layer does not have a feedback mechanism, and feedback information is carried at an RLC layer. As shown in FIG. 6, this embodiment specifically includes the following steps.

Step 601: A base station sends n RLC PDUs to UE.

The RLC PDUs sent by the base station to the UE are data information, and n is greater than or equal to 1.

Step 602: The UE receives an RLC PDU sent by the base station, determines whether information transmitted in the RLC PDU is correctly decoded, and generates an RLC PDU carrying feedback information.

Specifically, if the RLC PDU sent by the base station to the UE includes data information, a format of the feedback information in the RLC PDU generated by the UE includes: a data identifier and N information bits. The data identifier is D; 0 denotes NACK, and 1 denotes ACK; and the first bit corresponds to the first RLC PDU of n RLC PDUs that are sent by the base station, the second bit corresponds to the second RLC PDU of the n RLC PDUs that are sent by the base station, and the like.

Step 603: The UE sends, to the base station, the RLC PDU carrying the feedback information.

Further, the base station determines, according to the received feedback information, whether to send a next RLC PDU. If the feedback information received by the base station is 0, the RLC PDU that fails to be sent last time is re-sent to the UE, and if the feedback information received by the base station is 1, a next RLC PDU is sent to the UE.

In the method for sending feedback information provided in this embodiment, feedback information is carried in an RLC PDU, to enable a receive end to transmit feedback information without using a PUCCH/PHICH feedback channel, so as to improve system efficiency.

### Embodiment 4

This embodiment provides a method for sending feedback information. Similarly, an uplink feedback for downlink data is used as an example. A difference from Embodiment 1 lies in that a base station sends feedback information in a group feedback manner. As shown in FIG. 7, this embodiment specifically includes the following steps.

Step 701: User equipment sends data to a base station; and correspondingly, the base station receives the data sent by the user equipment.

The base station is preconfigured with: one common RNTI, a grouping quantity M of user equipments, and M receive patterns that include a feedback information receiving parameter of a group to which the user equipment belongs, where the receive patterns include the feedback information receiving parameter of the group of the user equipment, and M groups of the user equipments correspond to the M receive patterns one by one.

Specifically, according to an identifier of the user equipment modulo M, where the identifier of the user equipment is carried in the data sent by the user equipment, the base station obtains that a group identifier of the user equipment is 4, and finds, by using the group identifier 4 of the user equipment, a corresponding receive pattern whose sequence number is 4, so as to obtain the feedback information receiving parameter of the user equipment.

Step 702: The base station generates feedback information according to the received data sent by the user equipment, where the feedback information is used to identify whether the base station correctly receives the data sent by the user equipment.

Step 703: The base station sends, to the user equipment, the feedback information scheduled by using a physical downlink control channel PDCCH scrambled with a radio network temporary identifier RNTI; and correspondingly, the user equipment receives the feedback information sent by the base station.

Specifically, the base station sends, to the user equipment according to a feedback information receiving parameter of a group to which the user equipment belongs, the feedback information scheduled by using a PDCCH scrambled with one common RNTI. Correspondingly, the user equipment receives the feedback information that is sent by the base station and that is scheduled, when the feedback information receiving parameter of the group to which the user equipment belongs is used, by using the PDCCH scrambled with one common RNTI.

In the method for sending feedback information provided in this embodiment, for a downlink feedback for uplink data, a base station uses a group feedback manner, and feedback information is scheduled by using a PDCCH scrambled with an RNTI, so that feedback information can be transmitted without using a PUCCH/PHICH feedback channel, thereby improving system efficiency.

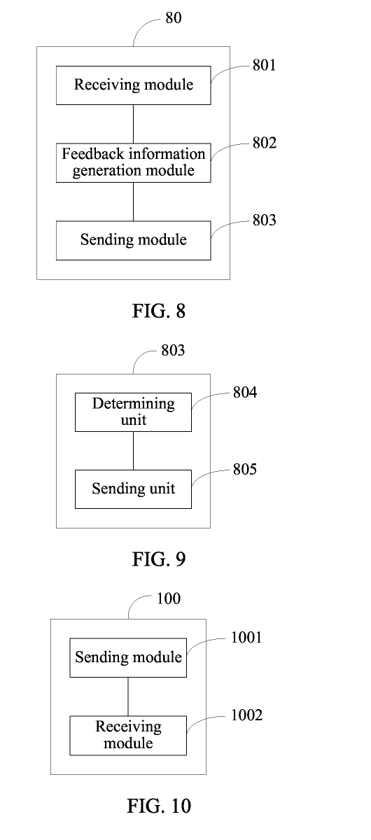

Embodiments provide a device 80 for sending feedback information, and as shown in FIG. 8, the device 80 for sending feedback information includes: a receiving module 801, configured to receive data sent by a transmit end device; and a feedback information generation module 802, configured to generate, according to the data received by the receiving module 801, a protocol data unit PDU carrying feedback information, where the feedback information is used to indicate whether the receive end device receives the data correctly. The device also includes a sending module 803, configured to send, to the transmit end device, the PDU that is generated by the feedback information generation module 802 and that carries the feedback information.

Optionally, the feedback information generation module 802 is specifically configured to generate, according to the data received by the receiving module 801, a media access control MAC layer PDU carrying the feedback information.

That the feedback information generation module 802 generates a MAC layer PDU carrying the feedback information includes: using a bit in any sub-header of the MAC PDU to carry the feedback information about whether the data is received correctly; or using a control information element CE in the MAC PDU to carry the feedback information about whether the data is received correctly, where the MAC PDU includes a logical channel identifier LCID used to denote that the MAC CE is used to carry the feedback information.

Further, the using a control information element CE in the MAC PDU to carry the feedback information about whether the data is received correctly includes: the MAC CE includes N information bits, and the information bits correspond to HARQ process IDs; or the MAC CE includes N information bits and one HARQ process ID, where any one of the N information bits corresponds to the HARQ process ID, and the remaining N−1 information bits correspond to other HARQ process IDs; where each of the information bits is used to denote whether the receive end device correctly receives data that is sent by the transmit end device and that corresponds to a HARQ process ID.

Alternatively, optionally, the feedback information generation module 802 is specifically further configured to generate, according to the data received by the receiving module 801, a radio link control RLC layer PDU carrying the feedback information.

The RLC PDU includes: a data identifier and N information bits, and the N information bits correspond to the data received by the receive end device; or a control identifier, a control content identifier, and N information bits, and the N information bits correspond to control information received by the receive end device; where each of the information bits is used to denote whether the receive end device correctly receives data that is sent by the transmit end device and that corresponds to a process ID.

Further, the sending module 803 further includes: a determining unit 804 and a sending unit 805, as shown in FIG. 9.

The determining unit 804 is configured to determine a sending time of the PDU carrying the feedback information.

The sending unit 805 is configured to send, to the transmit end device at the sending time determined by the determining unit 804, the PDU carrying the feedback information.

Optionally, the determining unit 804 is specifically configured to determine, according to a moment when the receive end device receives the data, a quantity of times that the receive end device receives the data, and a time during which the receive end device processes the received data, a sending moment for sending a feedback.

Alternatively, optionally, the determining unit 804 is specifically further configured to determine the sending moment of the feedback according to a first formula, where the first formula is:

T=t+n−1+k,

where T denotes the sending moment of the feedback, t denotes a moment when the receive end device receives the data, n denotes a quantity of times that the receive end device repeats the received data, and k denotes a time during which the receive end device processes the received data.

Alternatively, optionally, the determining unit 804 is specifically further configured to determine, according to a moment when the receive end device receives the data, a quantity of times that the receive end device receives the data, a time during which the receive end device processes the received data, and a feedback time window preconfigured by the receive end device, a sending time period for sending the feedback information.

Alternatively, optionally, the determining unit 804 is specifically further configured to determine a start moment T1 of a sending time period according to a second formula, and determine an end moment T2 of the sending time period according to a third formula, where the second formula is:

T1=t+n−1+k, and

the third formula is:

T2=t+n−1+k+w,

where t denotes a moment when the receive end device receives the data, n denotes a quantity of times that the receive end device repeats the received data, k denotes a time during which the receive end device processes the received data, and w denotes a feedback time window preconfigured by the receive end device.

The feedback time window preconfigured by the receive end device is a fixed value configured initially.

Further, if the receive end device is user equipment, and the transmit end device is a base station, the feedback time window preconfigured by the receive end device is configured for the receive end device by the transmit end device by using a radio resource control RRC message.

Further, the sending unit 805 is further configured to send, by the receive end device, the feedback information to the transmit end device at the first moment, within the sending time period, having a first resource, where the first resource is a resource that can be used to send the feedback information.

Further, the sending module 803 is further configured to send, in a case without a limit of a sending moment or a sending time period for sending a feedback by a user, to the transmit end device, the first PDU that has data to be sent and that carries the feedback information.

In the apparatus for sending feedback information provided in this embodiment of the present invention, feedback information is carried in a MAC PDU or feedback information is carried in an RLC PDU, to enable a receive end to transmit feedback information without using a PUCCH/PHICH feedback channel, so as to improve system efficiency.

Embodiments provide a device 100 for sending feedback information. The device 100 is user equipment, and includes: a sending module 1001 and a receiving module 1002, as shown in FIG. 10, where the sending module 1001 is configured to send data to a base station; and the receiving module 1002 is configured to receive feedback information that is sent by the base station and that is scheduled by using a physical downlink control channel PDCCH scrambled with a radio network temporary identifier RNTI, where the feedback information is used to indicate whether the base station receives the data correctly.

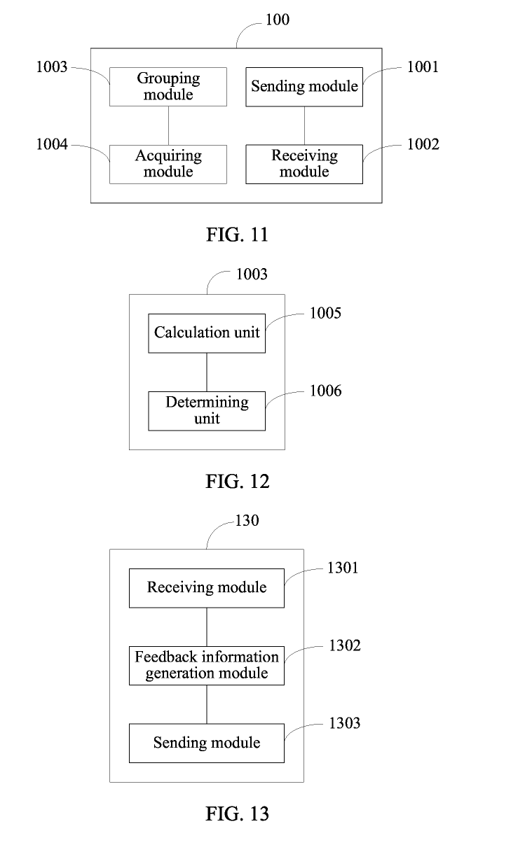

Further, the device 100 further includes: a grouping module 1003 and an acquiring module 1004, as shown in FIG. 11, where the grouping module 1003 is configured to perform grouping according to an identifier of the user equipment, to obtain a group identifier. The acquiring module 1004 is configured to acquire, according to the group identifier obtained by the grouping module 1003, a feedback information receiving parameter of a group to which the user equipment belongs, where the feedback information receiving parameter is used to identify that the user equipment receives, on an allocated resource, the feedback information that is sent by the base station. The receiving module 1002 is further configured to receive the feedback information that is sent by the base station and that is scheduled, when the feedback information receiving parameter of the group to which the user equipment belongs is used, by using the PDCCH scrambled with one common RNTI.

Optionally, the acquiring module 1004 is further configured to acquire, according to the group identifier obtained by the grouping module 1003, the feedback information receiving parameter of the user equipment, and an RNTI of the group to which the user equipment belongs, where the feedback information receiving parameter is used to identify that the user equipment receives, on an allocated resource, the feedback information that is sent by the base station; and the receiving module 1002 is further configured to receive the feedback information that is sent by the base station and that is scheduled, when the feedback information receiving parameter is used, by using the PDCCH scrambled with the RNTI of the group to which the user equipment belongs.

Optionally, the acquiring module 1004 is further configured to acquire, according to the group identifier obtained by the grouping module 1003, the RNTI of the group to which the user equipment belongs.

The receiving module 1002 is further configured to receive the feedback information that is sent by the base station and that is scheduled, within a sending time period for sending a feedback, by using the PDCCH scrambled with the RNTI of the group to which the user equipment belongs, where the sending time period is a sending time period, for sending the feedback, determined after the base station processes the data sent by the user equipment.

Further, the grouping module 1003 includes: a calculation unit 1005 and a determining unit 1006, as shown in FIG. 12, where the calculation unit 1005 is configured to divide the identifier of the user equipment by a grouping quantity M, to obtain a remainder; and the determining unit 1006 is configured to use the remainder as the group identifier of the user equipment.

The grouping quantity M is configured for the user equipment by the base station in a broadcast manner, or the grouping quantity M is initially configured for the user equipment.

Further, the feedback information includes: an identifier of at least one user equipment, at least one HARQ process ID, and N information bits, where the N information bits correspond to the HARQ process ID, and each of the information bits is used to denote whether the base station correctly receives data that is sent by the user equipment and that corresponds to a HARQ process ID.

In the apparatus for sending feedback information provided in this embodiment of the present invention, feedback information is scheduled by using a PDCCH scrambled with an RNTI, to enable a receive end to transmit feedback information without using a PUCCH/PHICH feedback channel, so as to improve system efficiency.

Embodiments provide a device 130 for sending feedback information. The device 130 is a base station, and as shown in FIG. 13, includes: a receiving module 1301, a feedback information generation module 1302, and a sending module 1303, where the receiving module 1301 is configured to receive data sent by user equipment, where the data includes an identifier of the user equipment; the feedback information generation module 1302 generates feedback information according to the data that is sent by the user equipment and that is received by the receiving module 1301, where the feedback information is used to identify whether the base station correctly receives the data sent by the user equipment; and the sending module 1303 is configured to send, to the user equipment, the feedback information scheduled by using a physical downlink control channel PDCCH scrambled with a radio network temporary identifier RNTI.

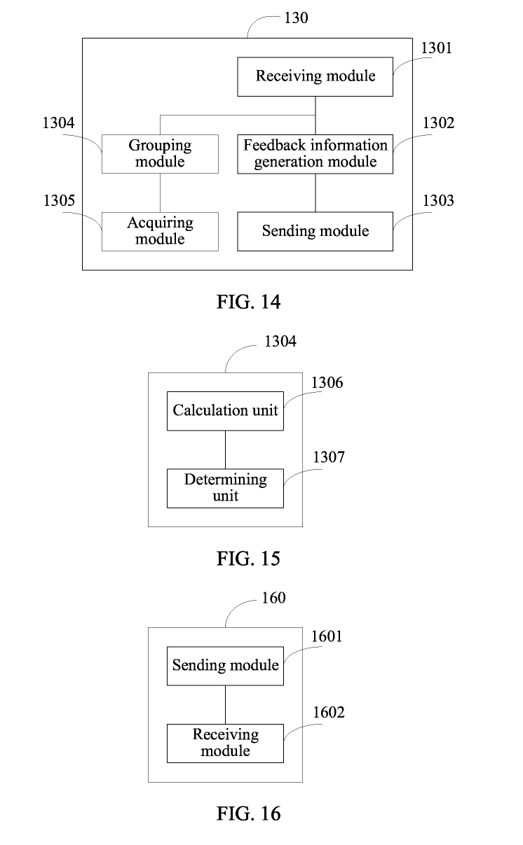

Further, the device 130 further includes: a grouping module 1304 and an acquiring module 1305, as shown in FIG. 14, where optionally, the device 130 is preconfigured with: one common RNTI, a grouping quantity M of user equipments, and a feedback information receiving parameter of a group to which the user equipment belongs; the grouping module 1304 is configured to: after the receiving module 1301 receives the data sent by the user equipment, perform grouping according to the identifier, of the user equipment, in the data sent by the user equipment, to obtain a group identifier of the user equipment; the acquiring module 1305 is configured to acquire, according to the group identifier obtained by the grouping module 1304, the feedback information receiving parameter of the group to which the user equipment belongs; and further, the sending module 1303 is specifically configured to send, to the user equipment according to the feedback information receiving parameter of the group to which the user equipment belongs, the feedback information scheduled by using the PDCCH scrambled with one common RNTI.

Alternatively, optionally, the device 130 is preconfigured with: a grouping quantity M of user equipments, M RNTIs, and a feedback information receiving parameter of the user equipment; the acquiring module 1305 is further configured to acquire, according to the group identifier obtained by the grouping module 1304, an RNTI of the group to which the user equipment belongs and the feedback information receiving parameter; and the sending module 1303 is further configured to send, to the user equipment according to the feedback information receiving parameter of the user equipment, the feedback information scheduled by using the PDCCH scrambled with the RNTI of the group to which the user equipment belongs.

Alternatively, optionally, the device 130 is preconfigured with: a grouping quantity M of user equipments, and M RNTIs, where groups of the user equipments correspond to the RNTIs one by one; the acquiring module 1305 is further configured to acquire, according to the group identifier obtained by the grouping module 1304, an RNTI of the group to which the user equipment belongs; and the sending module 1303 is further configured to send, to the user equipment, the feedback information that is scheduled, within a sending time period for sending a feedback, by using the PDCCH scrambled with the RNTI of the group to which the user equipment belongs, where the sending time period is a sending time period, for sending the feedback, determined after the base station processes the data sent by the user equipment.

Further, the grouping module 1304 includes: a calculation unit 1306 and a determining unit 1307, as shown in FIG. 15, where the calculation unit 1306 is configured to divide the identifier of the user equipment by the grouping quantity M, to obtain a remainder; and the determining unit 1307 is configured to use the remainder as the group identifier of the user equipment.

Further, the feedback information includes: an identifier of at least one user equipment, at least one HARQ process ID, and N information bits, where the N information bits correspond to the HARQ process ID, and each of the information bits is used to denote whether the base station correctly receives data that is sent by the user equipment and that corresponds to a HARQ process ID.

For the apparatus for sending feedback information provided in this embodiment of the present invention, feedback information is scheduled by using a PDCCH scrambled with an RNTI, to enable a receive end to transmit feedback information without using a PUCCH/PHICH feedback channel, so as to improve system efficiency.

Embodiments provide a device 160 for sending feedback information. The device 160 is a base station, and as shown in FIG. 16, includes: a sending module 1601 and a receiving module 1602, where the sending module 1601 is configured to send uplink-downlink time configuration information to user equipment, where the user equipment supports a change in uplink-downlink time ratio allocation; and the receiving module 1602 is configured to receive feedback information sent by the user equipment, where the feedback information is used to identify whether the user equipment receives the uplink-downlink time configuration information sent by the base station.

Optionally, the receiving module 1602 is further configured to receive a media access control MAC layer PDU that is sent by the user equipment and that carries the feedback information.

The media access control MAC layer PDU that carries the feedback information includes: using a bit in any sub-header of the MAC PDU to carry the feedback information about whether the user equipment receives the uplink-downlink time configuration information sent by the base station; or using a logical channel identifier LCID of the MAC PDU to identify the feedback information about whether the user equipment receives the uplink-downlink time configuration information sent by the base station; or using a control information element CE in the MAC PDU to carry the feedback information about whether the user equipment receives the uplink-downlink time configuration information sent by the base station, where the MAC PDU includes a logical channel identifier LCID used to identify that the MAC CE is used to carry the feedback information.

Alternatively, optionally, the receiving module 1602 is further configured to receive an enhanced scheduling request SR that is sent by the user equipment and that carries the feedback information.

Alternatively, optionally, the receiving module 1602 is further configured to receive an enhanced downlink-data uplink-feedback ACK/NACK that is sent by the user equipment and that carries the feedback information.

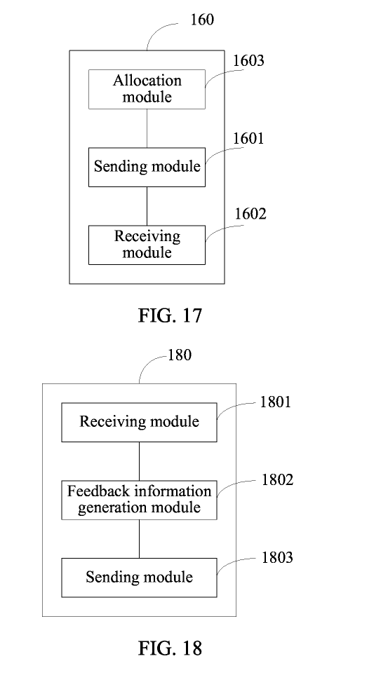

Further, the device 160 further includes: an allocation module 1603, as shown in FIG. 17, where the allocation module 1603 is configured to: before the sending module 1601 sends the uplink-downlink configuration information to the user equipment, allocate, to the user equipment, a resource used to feed back whether the uplink-downlink time configuration information is received; and the receiving module 1602 is further configured to receive, on the resource allocated to the user equipment, for the feedback, the feedback information sent by the user equipment.

Further, the receiving module 1602 is specifically configured to: if the user equipment receives the uplink-downlink time configuration information sent by the base station, receive, by the base station, the feedback information sent by the user equipment; and/or if the user equipment does not receive the uplink-downlink time configuration information sent by the base station, receive, by the base station, the feedback information sent by the user equipment.

In the device for sending feedback information provided in this embodiment, feedback information about whether user equipment receives uplink-downlink time configuration information sent by a base station is carried in a MAC PDU, or an enhanced scheduling request, or an enhanced downlink-data uplink-feedback ACK/NACK, or a base station directly allocates, to user equipment, a resource used for a feedback, so that the base station and the user equipment have consistent uplink-downlink time configuration information, thereby avoiding disordered scheduling between the base station and the user equipment, so as to achieve real-time, flexible adjustment of an uplink-downlink time configuration according to different services.

An embodiment provides a device 180 for sending feedback information. The device 180 is user equipment, and as shown in FIG. 18, includes: a receiving module 1801, a feedback information generation module 1802, and a sending module 1803, where the receiving module 1801 is configured to receive uplink-downlink time configuration information sent by a base station, where the user equipment supports a change in uplink-downlink time ratio allocation; the feedback information generation module 1802 is configured to generate feedback information according to whether the receiving module 1801 receives the uplink-downlink time configuration information sent by the base station, where the feedback information is used to identify whether the user equipment receives the uplink-downlink time configuration information sent by the base station; and the sending module 1803 is configured to send the feedback information to the base station.

Optionally, the feedback information generation module 1802 is configured to generate a media access control MAC layer PDU carrying the feedback information; and the sending module 1803 is configured to send, to the base station, the MAC PDU carrying the feedback information.

Specifically, the feedback information generation module 1802 is specifically configured to use a bit in any sub-header of the MAC PDU to carry the feedback information about whether the user equipment receives the uplink-downlink time configuration information sent by the base station; or use a logical channel identifier LCID of the MAC PDU to identify the feedback information about whether the user equipment receives the uplink-downlink time configuration information sent by the base station; or use a control information element CE in the MAC PDU to carry the feedback information about whether the user equipment receives the uplink-downlink time configuration information sent by the base station, where the MAC PDU includes a logical channel identifier LCID used to identify that the MAC CE is used to carry the feedback information.

Optionally, the feedback information generation module 1802 is further configured to generate an enhanced scheduling request SR carrying the feedback information; and the sending module 1803 is further configured to send, to the base station, the enhanced SR carrying the feedback information.

Optionally, the feedback information generation module 1802 is further configured to generate an enhanced downlink-data uplink-feedback ACK/NACK carrying the feedback information; and the sending module 1803 is further configured to send, to the base station, the enhanced downlink-data uplink-feedback ACK/NACK carrying the feedback information.

Optionally, the sending module 1803 is further configured to send the feedback information to the base station on a resource that is allocated by the base station to the user equipment and that is used to feed back whether the uplink-downlink time configuration information is received.

Further, the sending module 1803 is specifically configured to: if the user equipment receives the uplink-downlink time configuration information, send the feedback information to the base station; and/or if the user equipment does not receive the uplink-downlink time configuration information, send the feedback information to the base station.

In the device for sending feedback information provided in this embodiment of the present invention, feedback information about whether user equipment receives uplink-downlink time configuration information sent by a base station is carried in a MAC PDU, or an enhanced scheduling request, or an enhanced downlink-data uplink-feedback ACK/NACK, or a base station directly allocates, to user equipment, a resource used for a feedback, so that the base station and the user equipment have consistent uplink-downlink time configuration information, thereby avoiding disordered scheduling between the base station and the user equipment, so as to achieve flexible adjustment of an uplink-downlink time configuration according to different services.

An embodiment provides a system for sending feedback information, including: a receive end device, and the foregoing device 80 for sending feedback information; or the foregoing device 100 for sending feedback information, and the foregoing device 130 for sending feedback information; or the foregoing device 160 for sending feedback information, and the foregoing device 180 for sending feedback information.

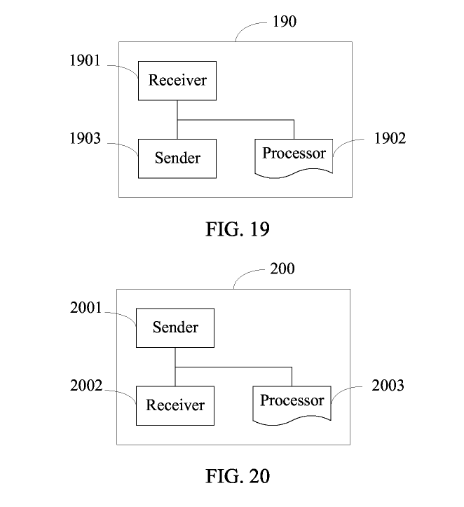

The present invention provides a device 190 for sending feedback information. The device 190 may be a base station, or may be user equipment, and includes: a receiver 1901, a processor 1902, a sender 1903, as shown in FIG. 19, where the receiver 1901 is configured to receive data sent by a transmit end device; the processor 1902 is configured to generate, according to the data received by the receiver 1901, a protocol data unit PDU carrying feedback information, where the feedback information is used to indicate whether the receive end device receives the data correctly; and the sender 1903 is configured to send, to the transmit end device, the PDU that is generated by the processor 1902 and that carries the feedback information.

Further, the processor 1902 is further configured to generate, according to the data received by the receiver 1901, a media access control MAC layer PDU carrying the feedback information.

That the processor 1902 generates a MAC layer PDU that carries the feedback information includes: using a bit in any sub-header of the MAC PDU to carry the feedback information about whether the data is received correctly; or using a control information element CE in the MAC PDU to carry the feedback information about whether the data is received correctly, where the MAC PDU includes a logical channel identifier LCID used to denote that the MAC CE is used to carry the feedback information.

Further, that the processor 1902 is configured to use a control information element CE in the MAC PDU to carry the feedback information about whether the data is received correctly includes: the MAC CE includes N information bits, and the information bits correspond to HARQ process IDs; or the MAC CE includes N information bits and one HARQ process ID, where any one of the N information bits corresponds to the HARQ process ID, and the remaining N−1 information bits correspond to other HARQ process IDs; where each of the information bits is used to denote whether the receive end device correctly receives data that is sent by the transmit end device and that corresponds to a HARQ process ID.

Further, the processor 1902 is further configured to generate, according to the data received by the receiver 1901, a radio link control RLC layer PDU carrying the feedback information, where the RLC PDU includes: a data identifier and N information bits, and the N information bits correspond to the data received by the receive end device; or a control identifier, a control content identifier, and N information bits, and the N information bits correspond to control information received by the receive end device; where each of the information bits is used to denote whether the receive end device correctly receives data that is sent by the transmit end device and that corresponds to a process ID.

Further, the processor 1902 is further configured to determine a sending time of the PDU carrying the feedback information.

Further, the processor 1902 is configured to determine, according to a moment when the receive end device receives the data, a quantity of times that the receive end device receives the data, and a time during which the receive end device processes the received data, a sending moment for sending a feedback.

Further, the processor 1902 is configured to determine the sending moment of the feedback according to a first formula, where the first formula is:

T=t+n−1+k,

where T denotes the sending moment of the feedback, t denotes a moment when the receive end device receives the data, n denotes a quantity of times that the receive end device repeats the received data, and k denotes a time during which the receive end device processes the received data.

Further, the processor 1902 is configured to determine, according to a moment when the receive end device receives the data, a quantity of times that the receive end device receives the data, a time during which the receive end device processes the received data, and a feedback time window preconfigured by the receive end device, a sending time period for sending the feedback information.

Further, the processor 1902 is configured to determine a start moment T1 of a sending time period according to a second formula, and determine an end moment T2 of the sending time period according to a third formula, where the second formula is:

T1=t+n−1+k, and

the third formula is:

T2=t+n−1+k+w,

where t denotes a moment when the receive end device receives the data, n denotes a quantity of times that the receive end device repeats the received data, k denotes a time during which the receive end device processes the received data, and w denotes a feedback time window preconfigured by the receive end device.

Further, the sender 1903 is further configured to send the feedback information to the transmit end device at the first moment, within the sending time period, having a first resource, where the first resource is a resource that can be used to send the feedback information.

Further, the sender 1903 is further configured to send, to the transmit end device, the first PDU that has data to be sent and that carries the feedback information.

The present invention provides user equipment 200, including: a sender 2001, a receiver 2002, and a processor 2003, as shown in FIG. 20, where the sender 2001 is configured to send data to a base station; and the receiver 2002 is configured to receive feedback information that is sent by the base station and that is scheduled by using a physical downlink control channel PDCCH scrambled with a radio network temporary identifier RNTI, where the feedback information is used to indicate whether the base station receives the data correctly.

Further, the processor 2003 is configured to perform grouping according to an identifier of the user equipment, to obtain a group identifier; and acquire, according to the group identifier, a feedback information receiving parameter of a group to which the user equipment belongs, where the feedback information receiving parameter is used to identify that the user equipment receives, on an allocated resource, the feedback information that is sent by the base station; and the receiver 2002 is further configured to receive the feedback information that is sent by the base station and that is scheduled, when the feedback information receiving parameter of the group to which the user equipment belongs is used, by using the PDCCH scrambled with one common RNTI.

Further, the processor 2003 is further configured to perform grouping according to an identifier of the user equipment, to obtain a group identifier; and acquire, according to the group identifier, the feedback information receiving parameter of the user equipment, and an RNTI of a group to which the user equipment belongs, where the feedback information receiving parameter is used to identify that the user equipment receives, on an allocated resource, the feedback information that is sent by the base station; and the receiver 2002 is further configured to receive the feedback information that is sent by the base station and that is scheduled, when the feedback information receiving parameter is used, by using the PDCCH scrambled with the RNTI of the group to which the user equipment belongs.

Further, the processor 2003 is further configured to perform grouping according to an identifier of the user equipment, to obtain a group identifier; and acquire, according to the group identifier, an RNTI of a group to which the user equipment belongs; and the receiver 2002 is further configured to receive the feedback information that is sent by the base station and that is scheduled, within a sending time period for sending a feedback, by using the PDCCH scrambled with the RNTI of the group to which the user equipment belongs, where the sending time period is a sending time period, for sending the feedback, determined after the base station processes the data sent by the user equipment.

Further, the processor 2003 is further configured to divide the identifier of the user equipment by a grouping quantity M, to obtain a remainder; and use the remainder as the group identifier of the user equipment.

The grouping quantity M is configured for the user equipment by the base station in a broadcast manner, or the grouping quantity M is initially configured for the user equipment.

Further, the feedback information includes: an identifier of at least one user equipment, at least one HARQ process ID, and N information bits, where the N information bits correspond to the HARQ process ID, and each of the information bits is used to denote whether the base station correctly receives data that is sent by the user equipment and that corresponds to a HARQ process ID.

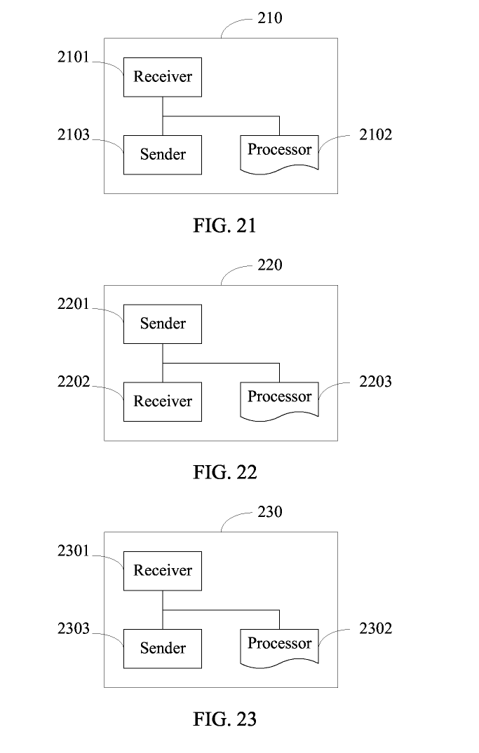

Embodiments provide a base station 210, including: a receiver 2101, a processor 2102, and a sender 2103, as shown in FIG. 21, where the receiver 2101 is configured to receive data sent by user equipment, where the data includes an identifier of the user equipment; the processor 2102 is configured to generate feedback information according to the data that is sent by the user equipment and that is received by the receiver 2101, where the feedback information is used to identify whether the base station correctly receives the data sent by the user equipment; and the sender 2103 is configured to send, to the user equipment, the feedback information scheduled by using a physical downlink control channel PDCCH scrambled with a radio network temporary identifier RNTI.

Further, the processor 2102 is further configured to perform grouping according to the identifier, of the user equipment, in the data sent by the user equipment, to obtain a group identifier of the user equipment; and acquire, according to the group identifier, a feedback information receiving parameter of a group to which the user equipment belongs; and the sender 2103 is further configured to send, to the user equipment according to the feedback information receiving parameter of the group to which the user equipment belongs, the feedback information scheduled by using the PDCCH scrambled with one common RNTI.

Further, the processor 2102 is further configured to perform grouping according to the identifier, of the user equipment, in the data sent by the user equipment, to obtain a group identifier of the user equipment; and acquire, according to the group identifier, an RNTI of a group to which the user equipment belongs and a feedback information receiving parameter; and the sender 2103 is further configured to send, to the user equipment according to the feedback information receiving parameter of the user equipment, the feedback information scheduled by using the PDCCH scrambled with the RNTI of the group to which the user equipment belongs.

Further, the processor 2102 is further configured to perform grouping according to the identifier, of the user equipment, in the data sent by the user equipment, to obtain a group identifier of the user equipment; and acquire, according to the group identifier, an RNTI of a group to which the user equipment belongs; and the sender 2103 is further configured to send, to the user equipment, the feedback information that is scheduled, within a sending time period for sending a feedback, by using the PDCCH scrambled with the RNTI of the group to which the user equipment belongs, where the sending time period is a sending time period, for sending the feedback, determined after the base station processes the data sent by the user equipment.

Further, the processor 2102 is further configured to divide the identifier of the user equipment by a grouping quantity M, to obtain a remainder; and use the remainder as the group identifier of the user equipment.

Further, the feedback information includes: an identifier of at least one user equipment, at least one HARQ process ID, and N information bits, where the N information bits correspond to the HARQ process ID, and each of the information bits is used to denote whether the base station correctly receives data that is sent by the user equipment and that corresponds to a HARQ process ID.

Embodiments provide a base station 220, including: a sender 2201, a receiver 2202, and a processor 2203, as shown in FIG. 22, where the sender 2201 is configured to send uplink-downlink time configuration information to user equipment, where the user equipment supports a change in uplink-downlink time ratio allocation; and the receiver 2202 is configured to receive feedback information sent by the user equipment, where the feedback information is used to identify whether the user equipment receives the uplink-downlink time configuration information sent by the base station.

Further, the receiver 2202 is further configured to receive a media access control MAC layer PDU that is sent by the user equipment and that carries the feedback information.

The media access control MAC layer PDU that carries the feedback information includes: using a bit in any sub-header of the MAC PDU to carry the feedback information about whether the user equipment receives the uplink-downlink time configuration information sent by the base station; or using a logical channel identifier LCID of the MAC PDU to identify the feedback information about whether the user equipment receives the uplink-downlink time configuration information sent by the base station; or using a control information element CE in the MAC PDU to carry the feedback information about whether the user equipment receives the uplink-downlink time configuration information sent by the base station, where the MAC PDU includes a logical channel identifier LCID used to identify that the MAC CE is used to carry the feedback information.

Further, the receiver 2202 is further configured to receive an enhanced scheduling request SR that is sent by the user equipment and that carries the feedback information.

Further, the receiver 2202 is further configured to receive an enhanced downlink-data uplink-feedback ACK/NACK that is sent by the user equipment and that carries the feedback information.

Further, the processor 2203 is configured to allocate, to the user equipment, a resource used to feed back whether the uplink-downlink time configuration information is received; and the receiver 2202 is further configured to receive, on the resource allocated to the user equipment for the feedback, the feedback information sent by the user equipment.

Further, the receiver 2202 is further configured to: if the user equipment receives the uplink-downlink time configuration information sent by the base station, receive feedback information sent by the user equipment; and/or if the user equipment does not receive the uplink-downlink time configuration information sent by the base station, receive feedback information sent by the user equipment.

Embodiments provide user equipment 230, including: a receiver 2301, a processor 2302, and a sender 2303, as shown in FIG. 23, where the receiver 2301 is configured to receive uplink-downlink time configuration information sent by a base station, where the user equipment supports a change in uplink-downlink time ratio allocation; the processor 2302 is configured to generate feedback information according to whether the uplink-downlink time configuration information sent by the base station is received, where the feedback information is used to identify whether the user equipment receives the uplink-downlink time configuration information sent by the base station; and the sender 2303 is configured to send the feedback information to the base station.

Further, the processor 2302 is further configured to generate a media access control MAC layer PDU carrying the feedback information; and the sender 2303 is further configured to send, to the base station, the MAC PDU carrying the feedback information.

The processor 2302 is specifically configured to use a bit in any sub-header of the MAC PDU to carry the feedback information about whether the user equipment receives the uplink-downlink time configuration information sent by the base station; or use a logical channel identifier LCID of the MAC PDU to identify the feedback information about whether the user equipment receives the uplink-downlink time configuration information sent by the base station; or use a control information element CE in the MAC PDU to carry the feedback information about whether the user equipment receives the uplink-downlink time configuration information sent by the base station, where the MAC PDU includes a logical channel identifier LCID used to identify that the MAC CE is used to carry the feedback information.

Further, the processor 2302 is further configured to generate an enhanced scheduling request SR carrying the feedback information; and the sender 2303 is further configured to send, to the base station, the enhanced SR carrying the feedback information.

Further, the processor 2302 is further configured to generate an enhanced downlink-data uplink-feedback ACK/NACK carrying the feedback information; and the sender 2303 is further configured to send, to the base station, the enhanced downlink-data uplink-feedback ACK/NACK carrying the feedback information.

Further, the sender 2303 is further configured to send the feedback information to the base station on a resource that is allocated by the base station to the user equipment and that is used to feed back whether the uplink-downlink time configuration information is received.

Further, the sender 2303 is further configured to: if the user equipment receives the uplink-downlink time configuration information, send the feedback information to the base station; and/or if the user equipment does not receive the uplink-downlink time configuration information, send the feedback information to the base station.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) to perform some of the steps of the methods described in the embodiments of the present invention. The foregoing storage medium includes: any medium that can store program code, such as a USB flash drive, a removable hard disk, a read-only memory (ROM for short), a random access memory (RAM for short), a magnetic disk, or an optical disc.

Finally, it should be noted that the foregoing embodiments are merely intended for describing the technical solutions of the present invention but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method, comprising:
receiving, by a receive end device, data sent by a transmit end device;
generating, by the receive end device, according to the received data, a protocol data unit (PDU) carrying feedback information, wherein the feedback information is indicates whether the receive end device received the data correctly; and
sending, by the receive end device, to the transmit end device, the PDU carrying the feedback information.

2. The method according to claim 1, wherein the PDU carrying the feedback information is a media access control (MAC) PDU.

3. The method according to claim 2, wherein the feedback information is carried in a bit of a sub-header of the MAC PDU.

4. The method according to claim 2, wherein:
the feedback information is carried in a MAC control information element (CE) in the MAC PDU; and
wherein a logical channel identifier (LCID) in the MAC PDU denotes the MAC CE that carries the feedback information.

5. The method according to claim 4, wherein the MAC CE comprises N information bits corresponding to a hybrid automatic repeat request (HARQ) process identifier, wherein N is an integer greater than or equal to 1.

6. The method according to claim 4, wherein the MAC CE comprises N information bits and a HARQ process identifier, wherein one of the N information bits corresponds to the HARQ process identifier and other N−1 information bits correspond to other HARQ process identifiers, wherein N is an integer greater than or equal to 1.

7. The method according to claim 1, wherein sending the PDU carrying the feedback information comprises:
determining, by the receive end device, a sending time of the PDU carrying the feedback information; and
sending, by the receive end device, to the transmit end device at the sending time, the PDU carrying the feedback information.

8. The method according to claim 1, wherein the PDU carrying the feedback information is a first PDU carrying data to be sent to the transmit end device.

9. A receive end device, comprising: a processor, a receiver coupled to the processor, and a transmitter coupled to the processor; wherein:
the receiver is configured to receive data sent by a transmit end device;
the processor is configured to generate, according to the received data, a protocol data unit (PDU) carrying feedback information, wherein the feedback information indicates whether the receive end device received the data correctly; and
a transmitter, configured to send, to the transmit end device, the PDU carrying the feedback information.

10. The device according to claim 9, wherein the PDU carrying the feedback information is a media access control (MAC) PDU.

11. The device according to claim 9, wherein the feedback information is carried in a bit of a sub-header of the MAC PDU.

12. The device according to claim 9, wherein the feedback information is carried in a MAC control information element (CE) in the MAC PDU, wherein a logical channel identifier (LCID) in the MAC PDU denotes the MAC CE that carries the feedback information.

13. The device according to claim 12, wherein the MAC CE comprises N information bits corresponding to a hybrid automatic repeat request (HARQ) process identifier, wherein N is an integer greater than or equal to 1.

14. The device according to claim 12, wherein the MAC CE comprises N information bits and a HARQ process identifier, wherein one of the N information bits corresponds to the HARQ process identifier and other N−1 information bits correspond to other HARQ process identifiers, wherein N is an integer greater than or equal to 1.

15. The device according to claim 9, wherein:
the processor is further configured to determine a sending time of the PDU carrying the feedback information; and
the transmitter is configured to send to the transmit end device, at the sending time, the PDU carrying the feedback information.

16. The device according to claim 9, wherein the PDU carrying the feedback information is a first PDU carrying data to be sent to the transmit end device.

17. A user equipment device (UE), comprising a transmitter and a receiver, wherein:
the transmitter is configured to send data to a base station;
the receiver is configured to receive feedback information from the base station; and
the feedback information indicates whether the base station received the data correctly and the feedback information is scheduled through a physical downlink control channel (PDCCH) that is scrambled with a radio network temporary identifier (RNTI).

18. The UE according to claim 17, further comprising:
a processor, configured to obtain a group identifier of the UE according to an identifier of the UE, and acquire a feedback receiving parameter of a group where the UE is located according to the group identifier of the UE, wherein the feedback information receiving parameter is used to determine that the UE received the feedback information on an allocated resource;
wherein the receiver is further configured to receive the feedback information through the feedback information receiving parameter.

19. The UE according to claim 18, wherein:
the processor is further configured to acquire, according to the group identifier of the UE, an RNTI of the group where the UE is located; and
the receiver is configured to receive the feedback information through the feedback information receiving parameter and the RNTI of the group where the UE is located.

20. The UE according to claim 17, wherein:
the feedback information comprises an identifier of the UE, a hybrid automatic repeat request (HARQ) process identifier, and N information bits corresponding to the HARQ process identifier; and
the N information bits are used to denote whether the base station correctly received from the UE data corresponding to the HARQ process identifier.
